(19) United States
(12) Patent Application Publication
(10) Pub. No.: US 2015/0108254 A1
(43) Pub. Date: Apr. 23, 2015

(54) SPRAY GUN

(71) Applicant: Polyurethane Machinery Corporation, Lakewood, NJ (US)

(72) Inventors: Denis S. Commette, Mantoloking, NJ (US); Vincent P. Adams, Lakehurst, NJ (US)

(21) Appl. No.: 14/516,622

(22) Filed: Oct. 17, 2014

Related U.S. Application Data
(60) Provisional application No. 61/894,058, filed on Oct. 22, 2013.

(51) Int. Cl. B05B 7/04

(52) U.S. Cl. CPC B05B 7/0408
USPC 239/428

(57) ABSTRACT

A spray gun comprises a first block and a mixing feature. The first block comprises a first sealing face, and a second sealing face. A first fluid passageway terminates in the first sealing face, while a second fluid passageway terminates in the second sealing face. The mixing feature comprises a third sealing face, a fourth sealing face, and a mixture chamber. The third sealing face is adjacent to the first sealing face and includes a first conduit in fluid communication with the first fluid passageway. The fourth sealing face is adjacent to the second sealing face and includes a second conduit in fluid communication with the second fluid passageway. The mixture chamber is in fluid communication with the first and second conduits and defines a longitudinal axis. The first, second, third, and fourth sealing faces are each oriented obliquely relative to the longitudinal axis of the mixing chamber.

### PRIORITY

This application claims priority to U.S. Provisional Pat. App. No. 61/894,058, entitled “Spray Gun,” filed Oct. 22, 2013, the disclosure of which is incorporated by reference herein.

### BACKGROUND

Applying polyurethane foam or other elastomeric coatings may be accomplished by mixing mutually reactive fluids to form a foam (e.g., polyurethane, etc.) that can cure on a substrate when the one or more fluids combine. Various devices and apparatuses have been developed to accomplish this application of foam, including spray guns. Merely exemplary spray guns and components are disclosed in U.S. Pat. No. 2,890,836, entitled “Apparatus for Applying a Mixture of a Plurality of Liquids,” issued Jun. 16, 1959; U.S. Pat. No. 3,263,928, entitled “Apparatus for Ejecting a Mixture of Liquids,” issued Aug. 2, 1966; U.S. Pat. No. 3,627,275, entitled “Apparatus for Producing Plastic Foam,” issued Dec. 14, 1971; U.S. Pat. No. 3,765,605, entitled “Apparatus for Ejecting a Mixture of Liquids,” issued Oct. 16, 1973; U.S. Pat. No. 3,876,145, entitled “Apparatus for Ejecting a Mixture of Plurality of Liquids,” issued Apr. 8, 1975; U.S. Pat. No. 4,377,256, entitled “Apparatus for Dispensing a Mixture of Mutually Reactive Liquids,” issued Mar. 22, 1983; U.S. Pat. No. 4,523,696, entitled “Apparatus for Dispensing a Mixture of Mutually Reactive Liquids,” issued Jun. 18, 1985; and U.S. Pat. No. 7,527,172, entitled “Plural Component Mixing and Dispensing Apparatus,” issued May 5, 2009. The disclosure of each of the above-cited U.S. Patents is incorporated by reference herein.

While several systems and methods have been made and used for spray guns, it is believed that no one prior to the inventor has made or used the invention described in the appended claims.

### BRIEF DESCRIPTION OF THE DRAWINGS

While the specification concludes with claims which particularly point out and distinctly claim this technology, it is believed this technology will be better understood from the following description of certain examples taken in conjunction with the accompanying drawings, in which like reference numerals identify the same elements and in which:

FIG. 1 depicts a perspective view of an exemplary spray gun;

FIG. 2 depicts another perspective view of the spray gun of FIG. 1;

FIG. 3 depicts a top plan view of the spray gun of FIG. 1;

FIG. 4 depicts a bottom plan view of the spray gun of FIG. 1;

FIG. 5 depicts a right elevational view of the spray gun of FIG. 1;

FIG. 6 depicts a left elevational view of the spray gun of FIG. 1;

FIG. 7 depicts a rear elevational view of the spray gun of FIG. 1;

FIG. 8 depicts a front elevational view of the spray gun of FIG. 1;

FIG. 9 depicts a partially exploded view of the spray gun of FIG. 1;

FIG. 10 depicts a side cross-sectional view of the spray gun of FIG. 1, taken along line 10-10 of FIG. 7;

FIG. 11 depicts a top cross-sectional view of the spray gun of FIG. 1, taken along line 11-11 of FIG. 5;

FIG. 12 depicts an enlarged cross-sectional view of a head assembly of the spray gun of FIG. 1, taken along line 11-11 of FIG. 5;

FIG. 13 depicts a partially exploded view of the head assembly of FIG. 12;

FIG. 14 depicts a perspective view of a mixing chamber insert of the head assembly of FIG. 12;

FIG. 15 depicts a top cross-sectional view of the mixing chamber insert of FIG. 14;

FIG. 16 depicts a perspective view of a block of the head assembly of FIG. 12;

FIG. 17 depicts a top cross-sectional view of the block of FIG. 16;

FIG. 18 depicts a perspective view of the head assembly of FIG. 12, with pattern control tip components separated from the remainder of the head assembly, and with a distal portion of the air cap shown in cross-section;

FIG. 19 depicts a side cross-sectional view of the head assembly of FIG. 12;

FIG. 20 depicts a top cross-sectional view of an exemplary valving rod assembly of the spray gun of FIG. 1;

FIG. 21 depicts a perspective view of a piston of the valving rod assembly of FIG. 20, with a valve rod separated from the piston;

FIG. 22 depicts an exploded view of the piston and valve rod of FIG. 21;

FIG. 23 depicts an exploded view of a manifold block separated from a piston chamber body of the spray gun of FIG. 1;

FIG. 24 depicts a cross-sectional perspective view of the manifold block of FIG. 23, taken along line 24-24 of FIG. 7;

FIG. 25 depicts a cross-sectional perspective view of the manifold block of FIG. 23, taken along line 25-25 of FIG. 7;

FIG. 26 depicts a cross-sectional side view of the manifold block and piston chamber body of FIG. 23, taken along line 10-10 of FIG. 7;

FIG. 27 depicts a cross-sectional side view of the manifold block and piston chamber body of FIG. 23, taken along line 24-24 of FIG. 7;

FIG. 28 depicts a cross-sectional side view of the manifold block and piston chamber body of FIG. 23, taken along line 25-25 of FIG. 7;

FIG. 29 depicts an exploded view of a spool valve and valve body configured for insertion in a manifold bore of the manifold block of FIG. 23;

FIG. 30A depicts a partial side cross-sectional view of the spray gun of FIG. 1, with a trigger and spool valve in a first position, taken along line 10-10 of FIG. 7;

FIG. 30B depicts a partial side cross-sectional view of the spray gun of FIG. 1, with the trigger and spool valve in a second position, taken along line 10-10 of FIG. 7; and

FIG. 31 depicts a perspective view of the spray gun of FIG. 1, with a hand grip separated from the remainder of the spray gun.

The drawings are not intended to be limiting in any way, and it is contemplated that various embodiments of the technology may be carried out in a variety of other ways, including those not necessarily depicted in the drawings. The accompanying drawings incorporated in and forming a part of the specification illustrate several aspects of the present technology, and together with the description serve to explain the principles of the technology; it being understood, however, that this technology is not limited to the precise arrangements shown.

### DETAILED DESCRIPTION

The following description of certain examples of the technology should not be used to limit its scope. Other examples, features, aspects, embodiments, and advantages of the technology will become apparent to those skilled in the art from the following description, which is by way of illustration, one of the best modes contemplated for carrying out the technology. As will be realized, the technology described herein is capable of other different and obvious aspects, all without departing from the technology. Accordingly, the drawings and descriptions should be regarded as illustrative in nature and not restrictive.

I. Overview

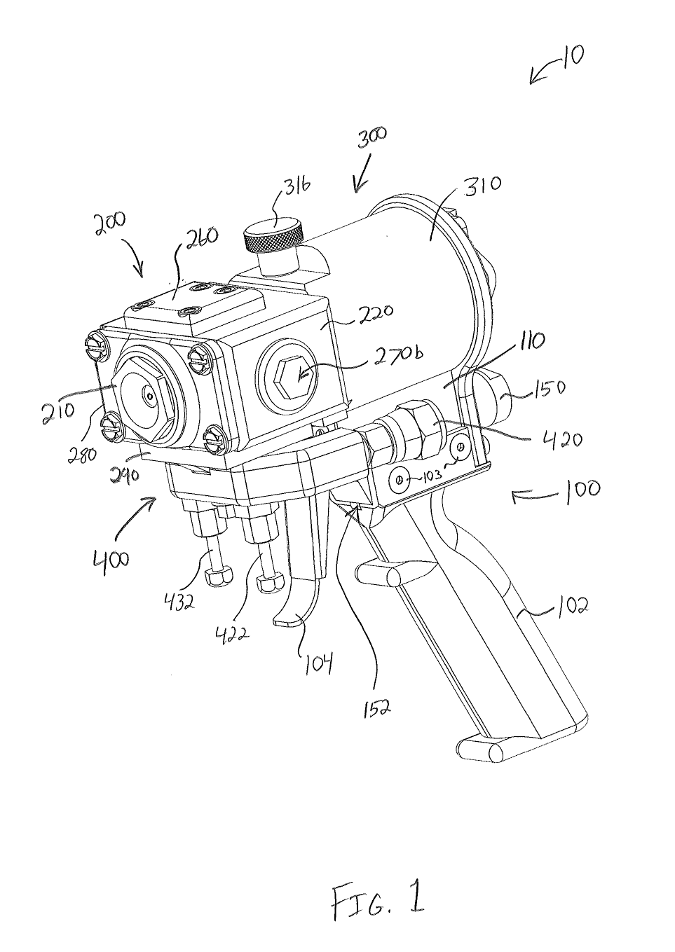

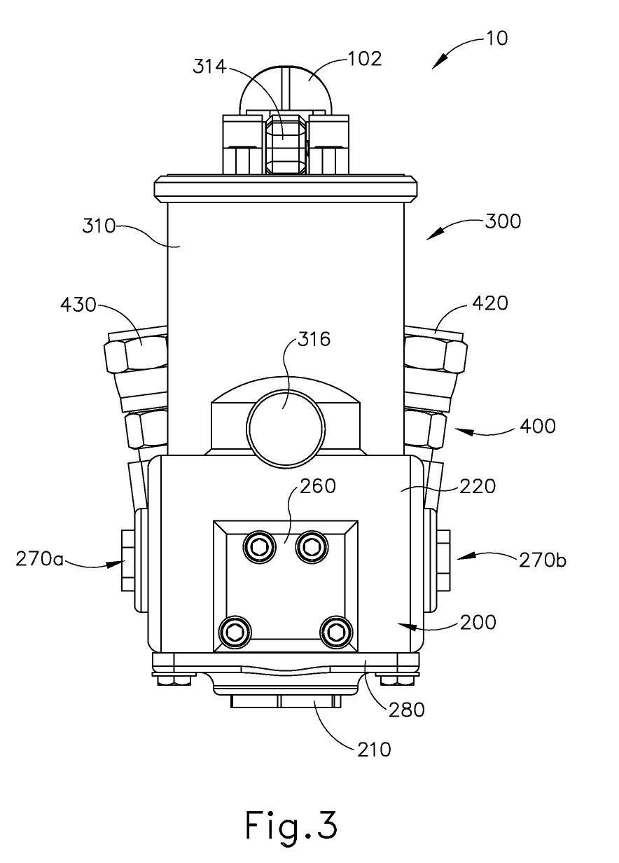

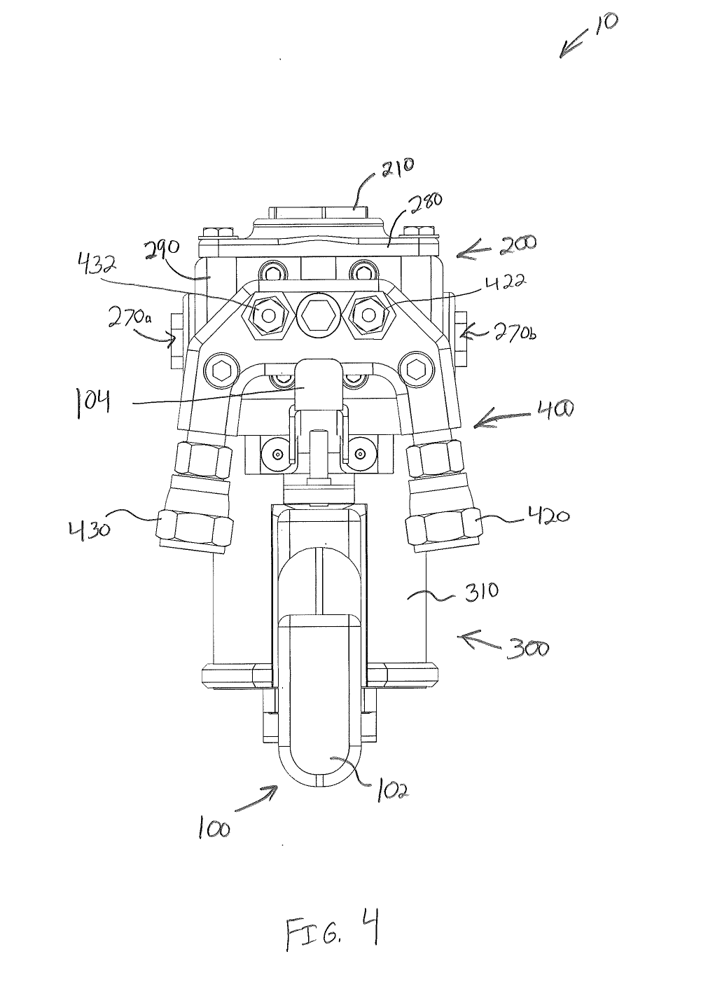

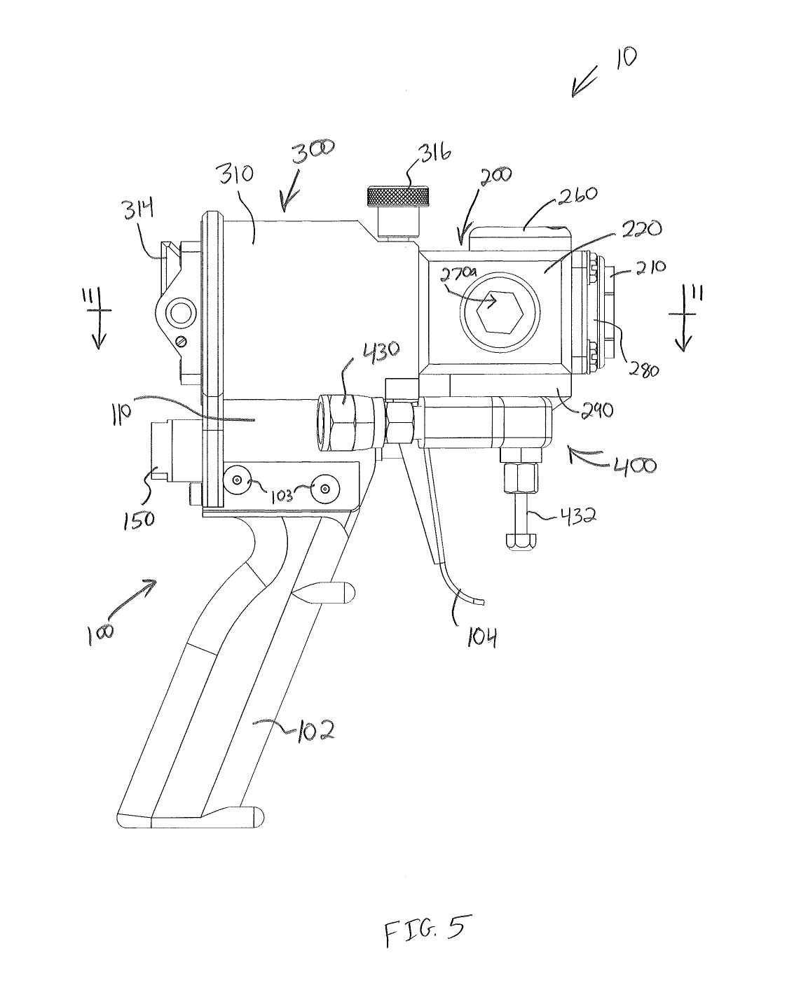

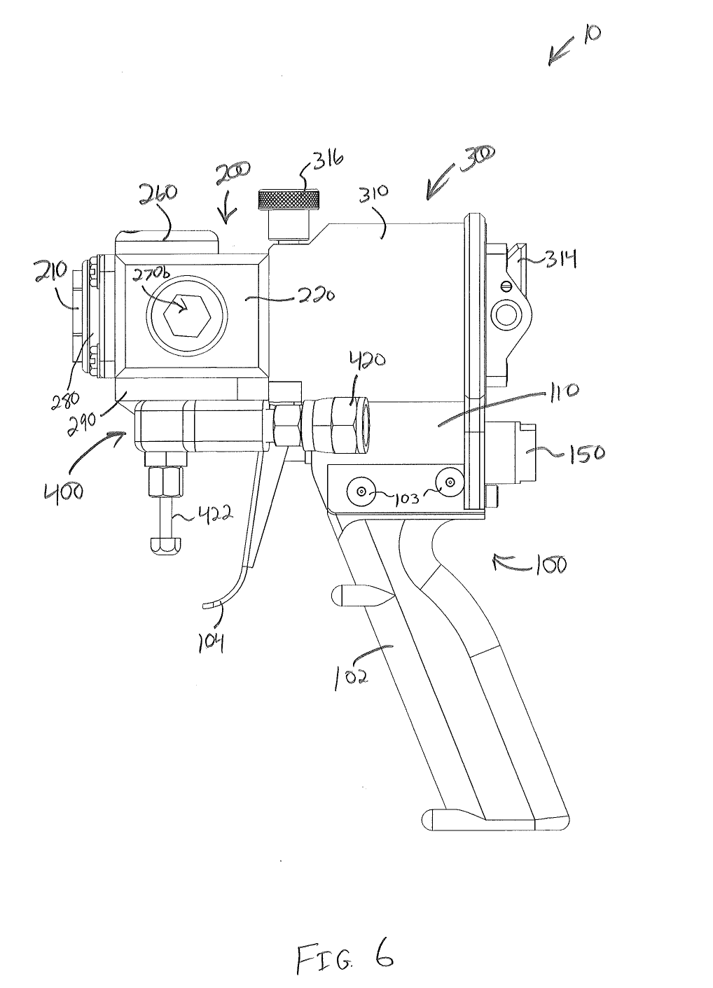

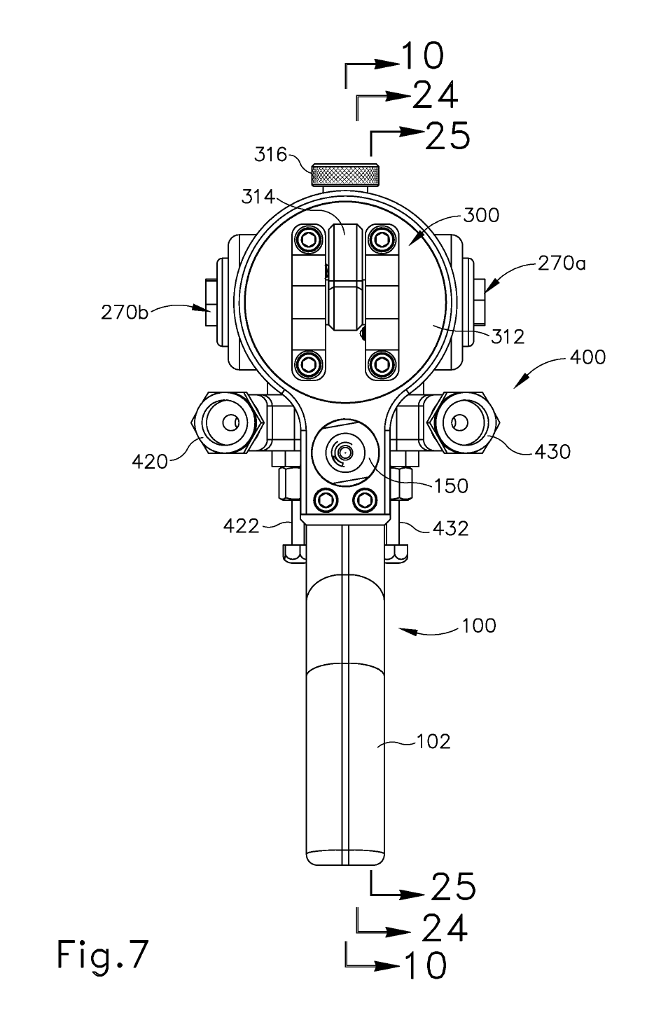

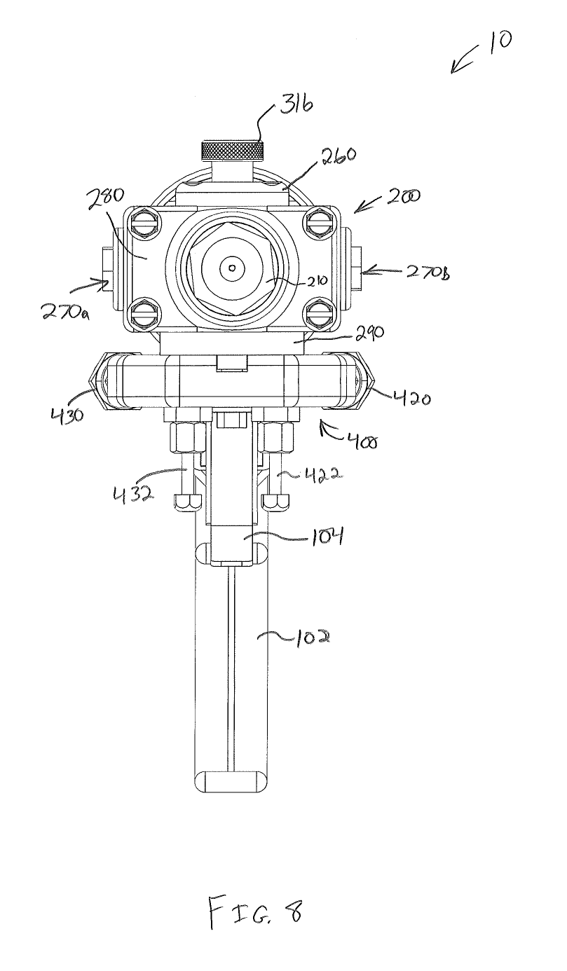

FIGS. 1-11 show an exemplary spray gun (10) that is operable to mix and dispense mutually reactive fluids to form a foam (e.g., polyurethane, etc.) that can cure on a substrate when the one or more fluids combine. Spray gun (10) of this example comprises a manifold assembly (100), a head assembly (200), a cylinder assembly (300), and a coupling block assembly (400). Manifold assembly (100) includes a pistol grip (102), a pivoting trigger (104), and a manifold block (110). Manifold assembly (100) also includes an inlet port (150) that is configured to couple with a source of pressurized fluid (e.g., compressed air, etc.). Cylinder assembly (300) is in selective fluid communication with a manifold chamber (112) in manifold block (110). Cylinder assembly (300) is operable to selectively actuate a valve rod (360) in head assembly to thereby expel a mixed material from head assembly (200) of spray gun (10), based on pivoting of trigger (104) toward grip (102). The mixed material comprises a mixture of materials from two sources, each source being coupled with a respective inlet port (420, 430) of coupling block assembly (400). The mixed material is dispensed from an air cap (210) of head assembly (200). Spray gun (10) includes features configured to maintain a stream of compressed fluid across air cap (210), including when mixed material is not being dispensed through air cap (210), to reduce the likelihood of the mixed material building up on air cap (210).

II. Exemplary Head Assembly

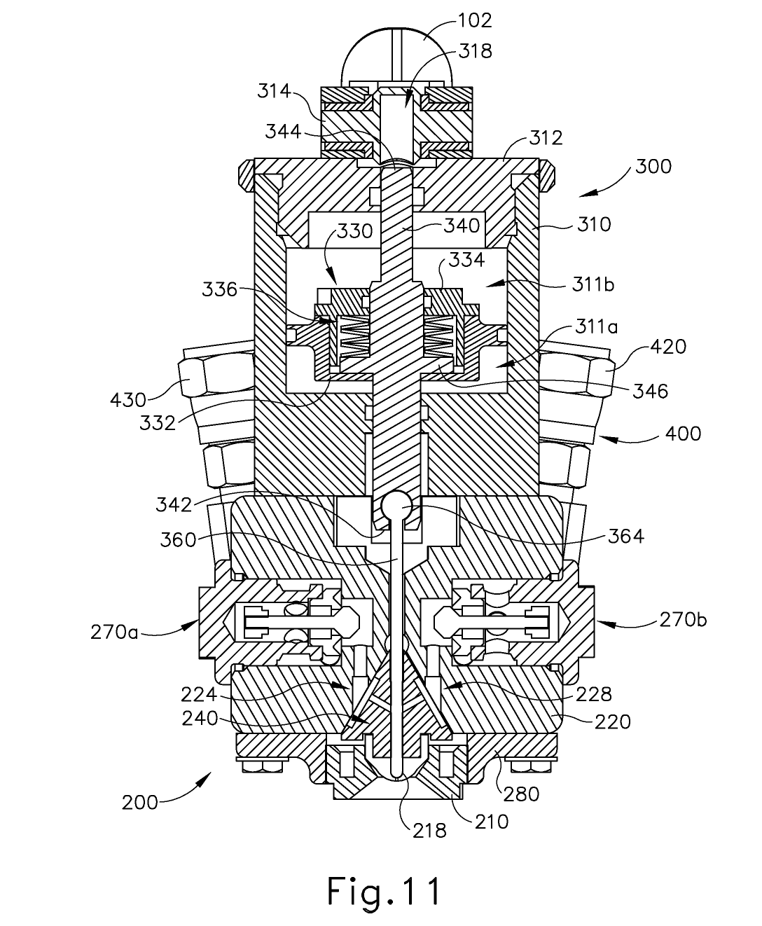

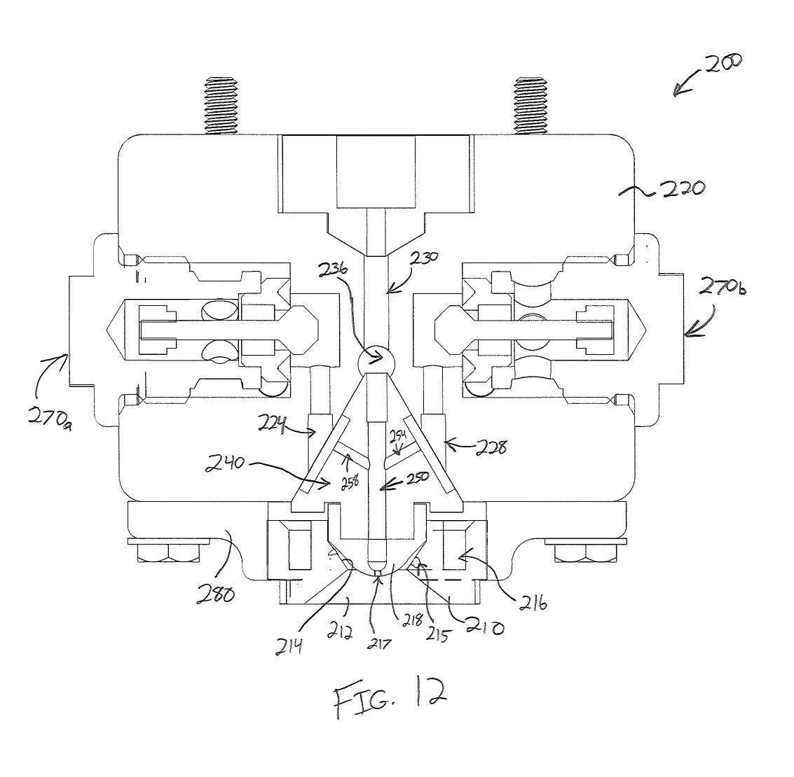

As best seen in FIGS. 11-18, head assembly (200) of the present example comprises air cap (210), a head block (220), a mixing chamber insert (240), a cover plate (260), a pair of spring compression valve assemblies (270a, 270b), a front plate (280), and a bottom plate (290). Head block (220) cooperates with front plate (280) to define a triangular recess (221) that is configured to receive mixing chamber insert (240). With mixing chamber insert (240) inserted in recess (221), cover plate (260) is positioned over mixing chamber insert (240) and then secured to head block (220) via a plurality of screws (266). Mixing chamber insert (240) is thereby vertically interposed between cover plate (260) and bottom plate (290). It should be understood that while cover plate (260) is shown as having a specific shape, the shape of cover plate (260) altered or modified without departing from the teachings herein. By way of example only, cover plate (260) may be reconfigured to cover the entire upper surface of head block (220), if desired. Various other suitable shapes and configurations that may be used for cover plate (260) will be apparent to those of ordinary skill in the art in view of the teachings herein.

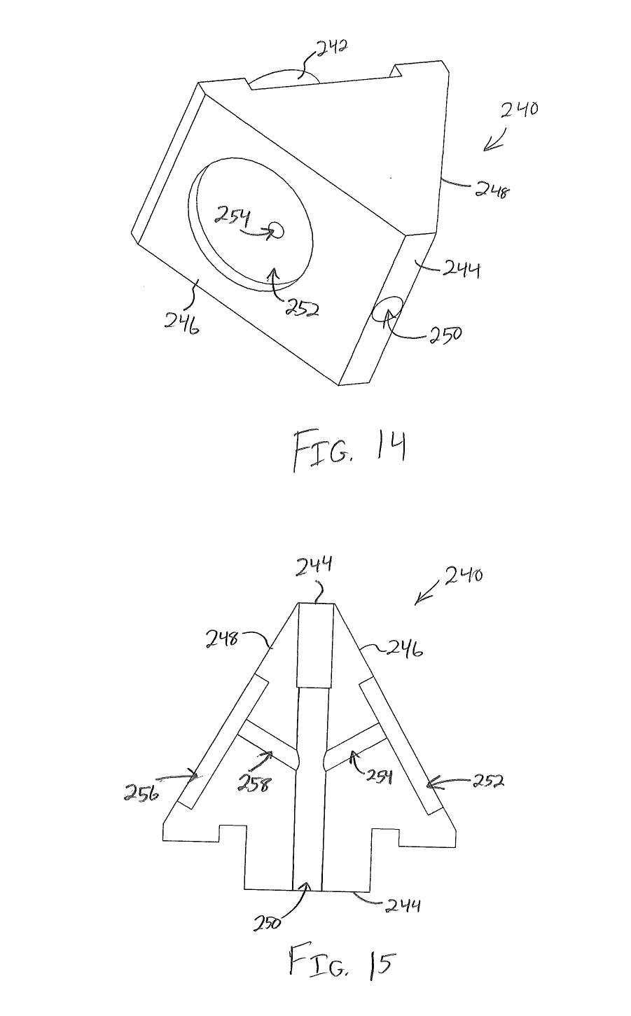

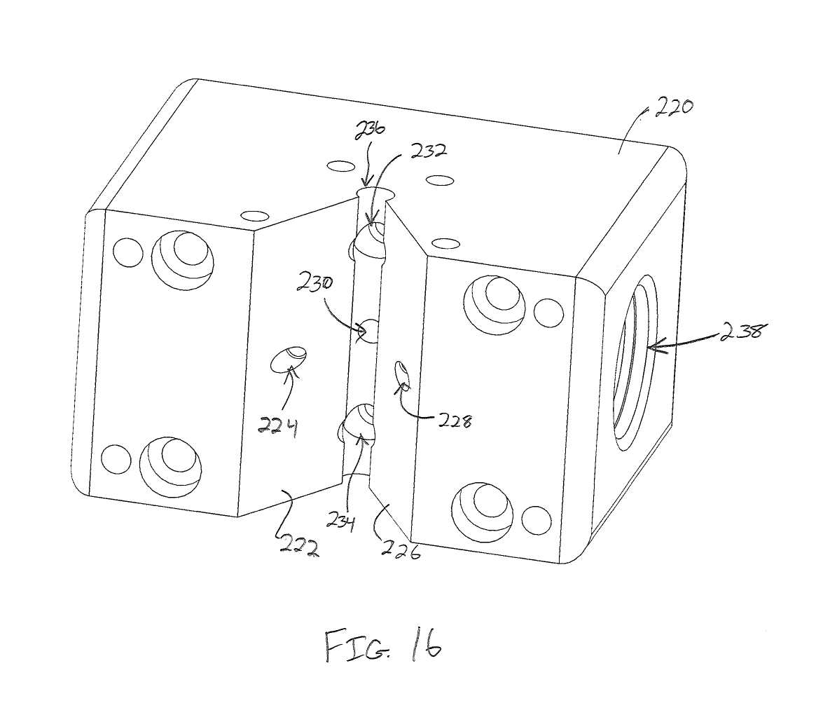

As best seen in FIGS. 14-15, mixing chamber insert (240) of the present example comprises a distal end (242), a proximal end (244), and a mixing passageway (250) extending between ends (242, 244). Mixing chamber insert (240) further includes a first angled side surface (246) and a second angled side surface (248). Side surfaces (246, 248) are both obliquely angled relative to the longitudinal axis of passageway (250), providing mixing chamber insert (240) with a generally triangular configuration. First angled side surface (246) defines a disc-shaped recess (252) that is in fluid communication with a first inlet passageway (254). First inlet passageway (254) is further in fluid communication with mixing passageway (250). First inlet passageway (254) is oriented normal to first angled side surface (246), such that first inlet passageway (254) is oriented obliquely relative to mixing passageway (250). Second angled side surface (248) defines a disc-shaped recess (256) that is in fluid communication with a second inlet passageway (258). Second inlet passageway (258) is further in fluid communication with mixing passageway (250). Second inlet passageway (258) is oriented normal to second angled side surface (248), such that second inlet passageway (258) is oriented obliquely relative to mixing passageway (250). It should also be understood that inlet passageways (254, 258) are oriented obliquely relative to each other in this example, though inlet passageways (254, 258) may instead have any other suitable relationships. For instance, inlet passageways (254, 258) may instead cooperate to define a right angle.

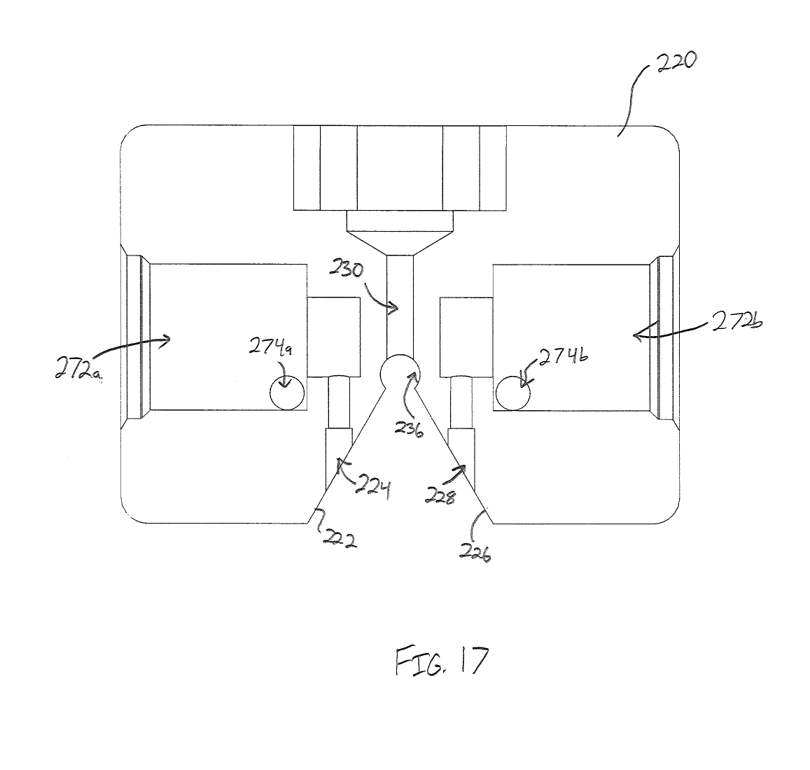

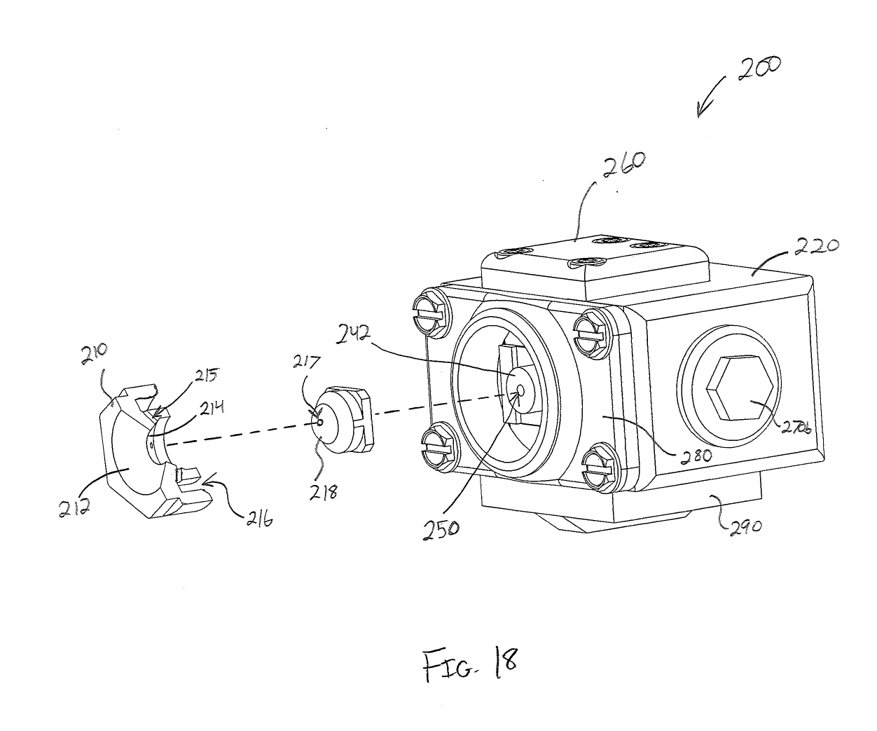

As best seen in FIGS. 16-17, head block (220) includes a first angled surface (222) and a second angled surface (226). First angled surface (222) of head block (220) contacts second angled side surface (248) of mixing chamber insert (240) when mixing chamber insert (240) is disposed in recess (221). Second angled surface (226) of head block (220) contacts first angled surface (246) of mixing chamber insert (240) when mixing chamber insert (240) is disposed in recess (221). Each angled surface (222, 226) of head block (220) includes a respective passageway (224, 228). Passageway (224) is in fluid communication with recess (256) and passageway (258) when mixing chamber insert (240) is disposed in recess (221). Passageway (228) is in fluid communication with recess (252) and passageway (254) when mixing chamber insert (240) is disposed in recess (221).

Each passageway (224, 228) in head block (220) is in fluid communication with a respective valve assembly chamber (272a, 272b). Each valve assembly chamber (272a, 272b) receives a respective spring compression valve assembly (270a, 270b). In addition, each valve assembly chamber (272a, 272b) includes a respective inlet port (274a, 274b). Each inlet port (239) is configured to couple with a respective outlet port (424, 434) of coupling block assembly (400) when spray gun (10) is fully assembled. Ports (274a, 274b, 424, 434) are configured to communicate mixture components received through respective inlet ports (420, 430) of coupling block assembly (400). It be understood from the foregoing that passageway (258) of mixing chamber insert (240) will receive the mixture component received through inlet port (430) of coupling block assembly (400); and passageway (254) of mixing chamber insert (240) will receive the mixture component received through inlet port (420) of coupling block assembly (400). When spray gun (10) is actuated as will be described in greater detail below, these mixture components will mix together in mixing passageway (250) of mixing chamber insert (240).

It should be understood that the oblique orientation of passageways (254, 258) relative to mixing passageway (250) may prevent crossover of materials expelled from passageways (254, 258). In other words, the oblique orientation may prevent material expelled from passageway (254) from crossing into passageway (258); and material expelled from passageway (258) from crossing into passageway (254). The oblique orientation may also reduce the likelihood of material becoming clogged in mixing passageway (250). Various suitable angles that may be used for the oblique orientation of passageways (254, 258) will be apparent to those of ordinary skill in the art in view of the teachings herein.

It should also be understood that the oblique orientation of side surfaces (246, 248) of mixing chamber insert (240) and angled surfaces (222, 226) of head block (220) may provide a substantial sealing interface by increasing the amount of surface area contact between head block (220) and mixing chamber insert (240). In other words, the surfaces of head block (220) and mixing chamber insert (240) that are in contact with each other adjacent to recesses (252, 256) and passageways (224, 228) are larger in the present example than they otherwise would be if surfaces (222, 226, 246, 248) were at a straight, longitudinally extending orientation. It should also be understood that the face seal created at surfaces (222, 226, 246, 248) may be greater than the seal that would otherwise be created by a conventional radial seal. The oblique orientation of surfaces (222, 226, 246, 248) may ultimately thus reduce the likelihood of fluid leakage at the interface of mixing chamber insert (240) and head block (220) as compared to other configurations. The oblique orientation of surfaces (222, 226, 246, 248) may also direct forces exerted between mixing chamber insert (240) and head block (220) along an inclined plane. Various suitable angles that may be used for the oblique orientation of surfaces (222, 226, 246, 248) will be apparent to those of ordinary skill in the art in view of the teachings herein.

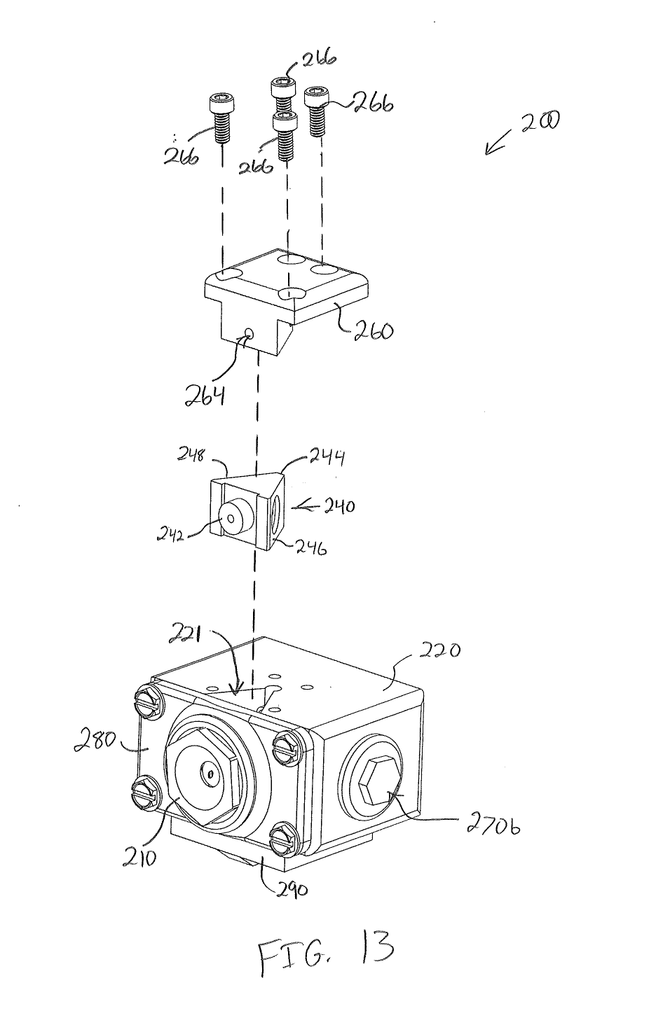

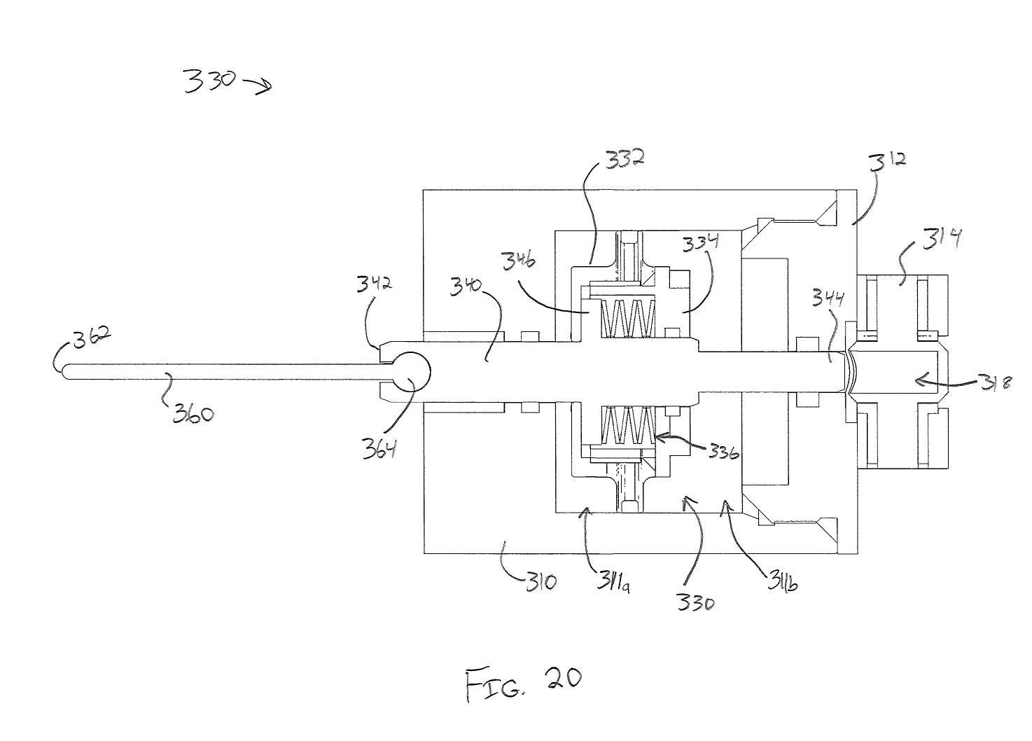

As best seen in FIGS. 16 and 19, head block (220) of the present example also defines a central passageway (230), an upper passageway (232), a lower passageway (234), and a vertical channel (236) at the vertex of the angle defined by angled surfaces (222, 226). Central passageway (230) is positioned to align with mixing passageway (250) of mixing chamber insert (240) when mixing chamber insert (240) is disposed in recess (221). Passageways (230, 250) thus together receive a valve rod (360) as will be described in greater detail below. As best seen in FIGS. 13 and 19, cover plate (260) defines a passageway (264), which is in fluid communication with upper passageway (232) of head block (220) via a sleeve (233). As best seen in FIG. 19, bottom plate (290) defines a passageway (292) that is in fluid communication with lower passageway (234) of head block (220) via a sleeve (235). It should be understood that sleeves (233, 235) provide fluid isolation between their respective sets of passageways (232, 264, 234, 292) and vertical channel (236) in the present example.

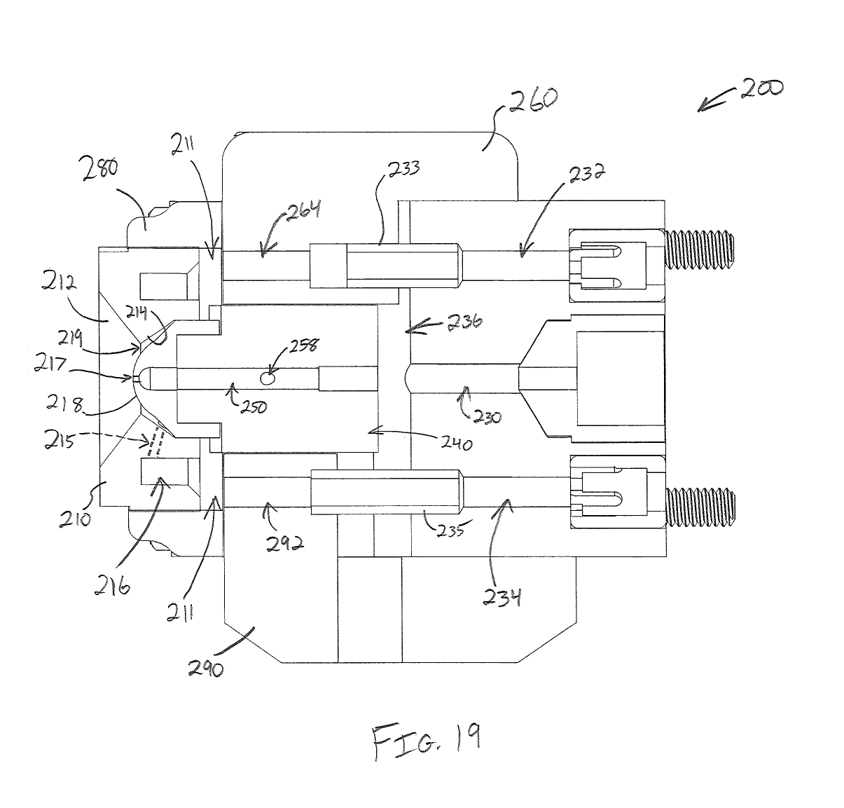

As best seen in FIGS. 18-19, air cap (210) of the present example includes an inverted frustoconical distal surface (212), a frustoconical proximal surface (214), and a proximally facing cylindraceous recess (216). A plurality of passageways (215) extend between recess (216) and frustoconical proximal surface (214). A pattern control tip (218) is interposed between frustoconical proximal surface (214) and the distal end (242) of mixing chamber insert (240). Pattern control tip (218) spaces air cap (210) distally away from mixing chamber insert (240), cover plate (260), and bottom plate (290). This creates a gap (211) that is in fluid communication with passageways (264, 292), recess (216), and passageways (215). Passageways (264, 292) are thus in fluid communication with passageways (215). As also seen in FIG. 19, a gap (219) is defined between the distal surface of pattern control tip (218) and frustoconical proximal surface (214). Passageways (215) are positioned to communicate with this gap (219). Passageways (264, 292) are thus in fluid communication with gap (219) via passageways (215). It should be understood that fluid communicated through passageways (264, 292) will thus be expressed through passageways (215), impinge against the distal surface of pattern control tip (218), and be ultimately expelled through gap (219).

As best seen in FIGS. 18-19, pattern control tip (218) includes a distal opening (217) that is in fluid communication with mixing passageway (250). As will be described in greater detail below, valve rod (360) is operable to translate between a distal position and a proximal position within mixing passageway (250). When valve rod (360) is in a distal position within mixing passageway (250), valve rod (360) prevents mixture components from being communicated through inlet passageways (254, 258) into mixing passageway (250). When valve rod (360) is in a proximal position within mixing passageway (250), valve rod (360) permits mixture components to be communicated through inlet passageways (254, 258) into mixing passageway (250). Those mixture components (i.e., mixture components originating through ports (420, 430)) will thus mix within mixing passageway (250) and travel distally through distal opening (217) of pattern control tip (218). As the mixture passes through distal opening (217) of pattern control tip (218), the pressurized fluid that is being expelled through gap (219) will distribute the mixture distally in a spray pattern. In other words, the pressurized fluid expelled through gap (219) combines with the mixture expelled through distal opening (217) to form a sprayed mixture.

In the present example, distal opening (217) is in the form of a round orifice or hole. It should be understood that the round configuration of distal opening (217) may provide a round spray pattern. It should also be understood that the depth and diameter of distal opening (217) will influence the velocity and back pressure associated with the spray. These properties may thus be varied by providing a selection of pattern control tips (218) with openings (217) of various depths and/or diameters (e.g., one associated with a high flow, one associated with a medium flow, and one associated with a low flow, etc.). It should also be understood that distal opening (217) may have some other configuration. By way of example only, distal opening (217) may be in the form of a horizontal slot formed by making a horizontal cut across the tip of pattern control tip (218). Such a horizontal, elongate configuration of opening (217) may provide a flat spray pattern. The depth and the angle of the horizontal cut may influence the flow and pattern of the spray. Again, these properties may be varied by providing a selection of pattern control tips (218) with openings (217) cut at various depths and/or angles (e.g., one associated with a high flow, one associated with a medium flow, and one associated with a low flow, etc.). Still other suitable ways in which opening (217) may be configured will be apparent to those of ordinary skill in the art in view of the teachings herein.

In some instances, it may be desirable to remove pattern control tip (218) for further cleaning, for replacement, to change the spray pattern, or for some other purpose. To that end, air cap (210) is readily removable from front plate (280) of head assembly (200). In some versions, air cap (210) has a threaded engagement with front plate (280), such that air cap (210) can effectively be screwed into or out of front plate (280) to selectively secure air cap (210) to front plate (280). Once air cap (210) is removed from front plate (280), pattern control tip (210) may be readily removed from distal end (242) of mixing chamber insert (240). This may facilitate cleaning, replacement, etc. of pattern control tip (218). In addition or in the alternative, this may facilitate further cleaning of mixing passageway (250). The same pattern control tip (218) or a different pattern control tip (218) may then be positioned on distal end (242) of mixing chamber insert (240); and the same air cap (210) or a different air cap (210) may be secured to front plate (280) to thereby capture pattern control tip (218) between air cap (210) and distal end (242) of mixing chamber insert (240). Other suitable relationships between these components will be apparent to those of ordinary skill in the art in view of the teachings herein.

III. Exemplary Cylinder Assembly

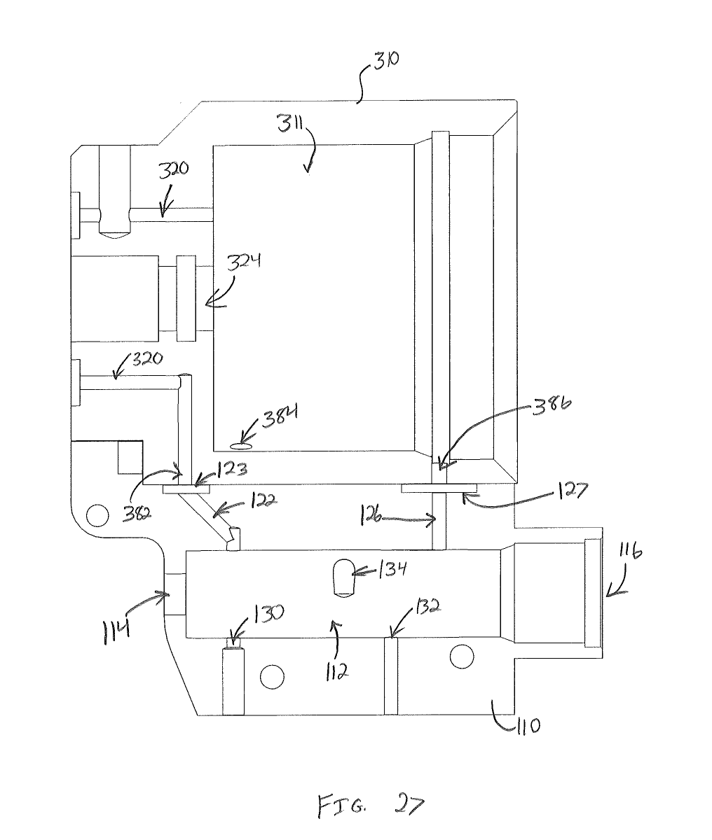

Cylinder assembly (300) of the present example comprises a cylinder body (310), an end cap (312), a locking member (314), and a piston assembly (330). Cylinder body (310) defines a hollow interior (311). End cap (312) closes off the proximal end of hollow interior (311). As best seen in FIGS. 26-27 and 30A-30B, an upper passageway (320), lower passageway (322), and central bore (324) are located at the distal end of hollow interior (311). When spray gun (10) is assembled, upper passageway (320) of cylinder body (310) is aligned with and in fluid communication with upper passageway (232) of head block (220); lower passageway (322) of cylinder body (310) is aligned with and in fluid communication with lower passageway (234) of head block (220); and central bore (324) of cylinder body (310) is aligned with central passageway (230) of head block (220). It should therefore be understood that upper passageway (320) of cylinder body (310) is further aligned with and in fluid communication with passageway (264) of cover plate (260); lower passageway (322) of cylinder body (310) is further aligned with and in fluid communication with passageway (292) of bottom plate (290); and central bore (324) of cylinder body (310) is further aligned with mixing passageway (250) of mixing chamber insert (240). In the present example, an adjustable needle valve (316) is coupled with upper passageway (320) of cylinder body (310). Needle valve (316) is operable to selectively adjust the flow rate through upper passageway (320). Of course, needle valve (316) may be varied, substituted, supplemented, or omitted as desired.

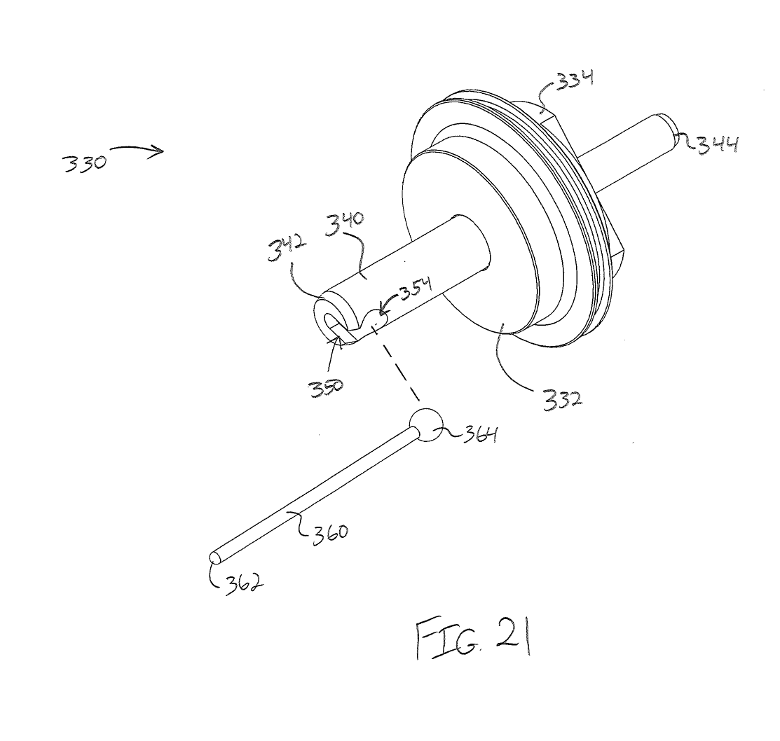

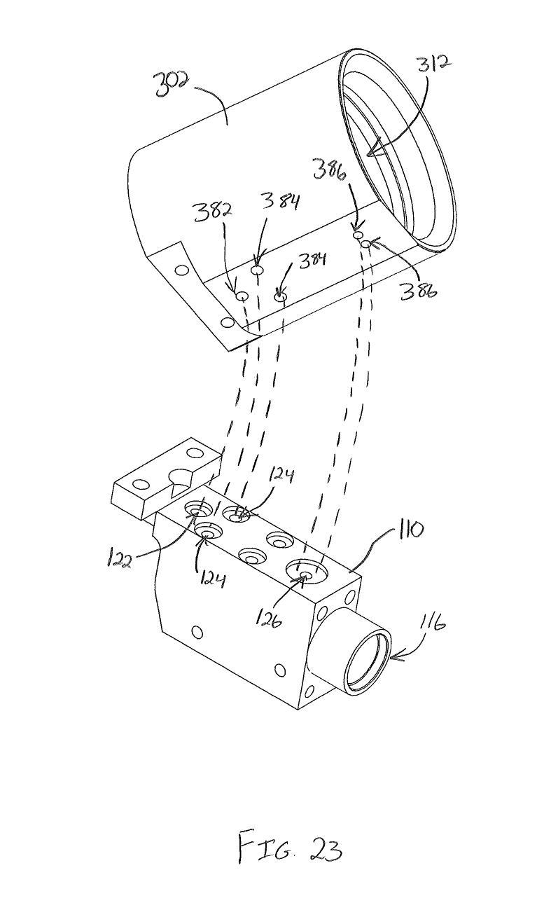

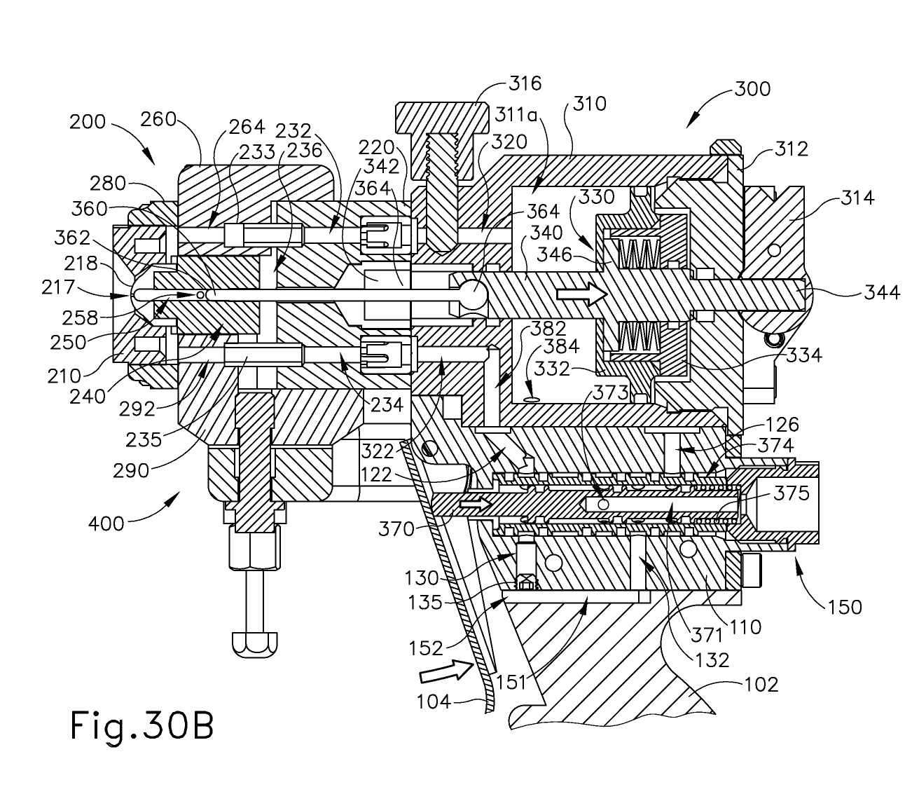

Piston assembly (330) is slidably disposed in bore (311) such that piston assembly (330) is operable to translate between a distal position as shown in FIG. 30A and a proximal position as shown in FIG. 30B. Piston assembly (330) effectively divides bore (311) into a distal portion (311a) and a proximal portion (311b). As best seen in FIGS. 20-22, piston assembly (330) of the present example comprises a distal cap (332), a proximal cap (334), a stack of resilient members (336), a stem (340), and a valve rod (360). In some versions, an o-ring is interposed between an outer perimeter of distal cap (332) and the inner diameter sidewall of bore (311). Such an o-ring may provide fluid isolation between portions (311a, 311b) of bore (311) while still permitting piston assembly (330) to slide within bore (311).

As shown in FIGS. 20-22, stem (340) includes a distal end (342), a proximal end (344), and a flange (344). Piston assembly (330) is configured and arranged such that distal end (342) of stem (340) protrudes distally from distal cap (332) and proximal end (344) of stem (340) protrudes proximally from proximal cap (334). Distal end (342) of stem (340) also protrudes through central bore (324); while proximal end (344) protrudes through end cap (312). Piston assembly (330) is further configured and arranged such that flange (344) of stem (340) and resilient members (336) are captured between caps (332, 334), which are secured together. Resilient members (336) are configured to bias stem (340) (and hence valve rod (360)) distally relative to caps (332, 334). In the present example, resilient members (336) comprise a series of Belleville washers arranged in an alternatingly opposed coaxial fashion. Alternatively, resilient members (336) may comprise any other suitable resilient feature or features, including but not limited to a coil spring. It should be understood that resilient members (336) may accommodate certain deformations that may occur in certain components of spray gun (10) during use of spray gun (10). For instance, the effective length of valve rod (360) may increase during use of spray gun (10) due to thermal expansion, vibration, etc. Instead of having such extension of valve rod (360) be borne solely by the opposing proximal face of pattern control tip (218), resilient members (336) may allow valve rod (360) to retract proximally relative to caps (332, 334) in response to the thermal expansion, vibration, etc. This may reduce the distally directed force borne against pattern control tip (218) by the distal tip (362) of valve rod (360).

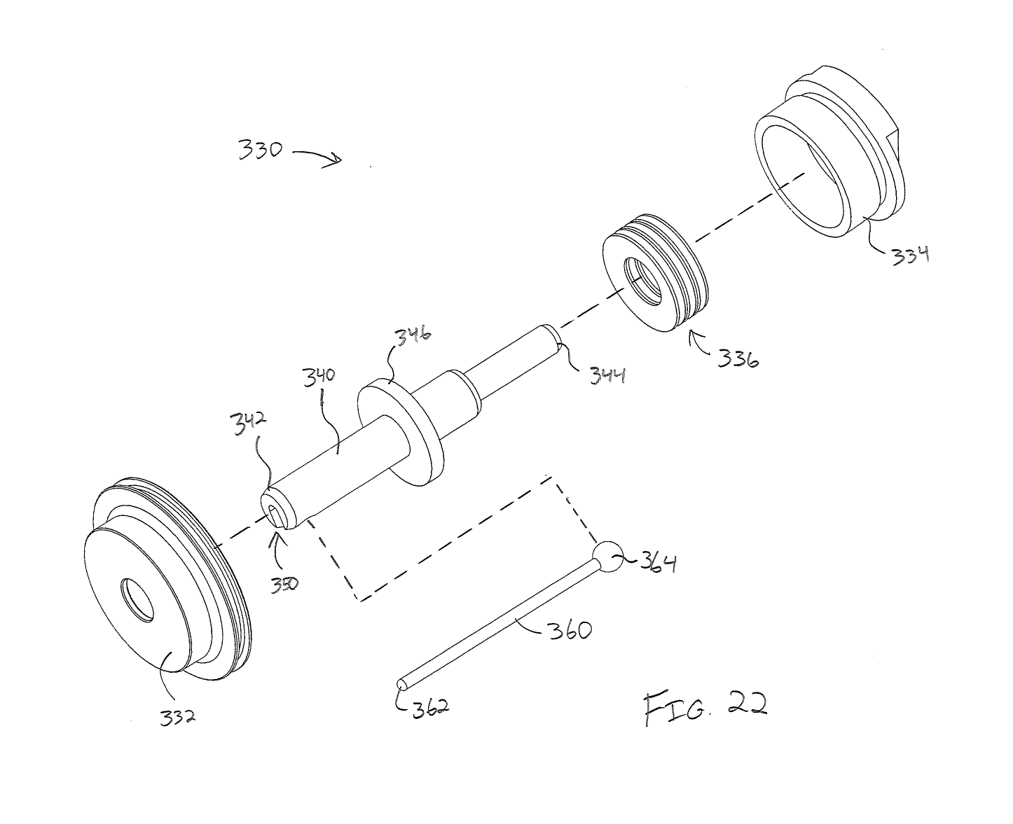

Valve rod (360) of the present example comprises a distal tip (362) and a proximal ball end (364). Ball end (364) is configured to fit in a slot (350) formed in distal end (342) of stem (340). As best seen in FIG. 21, slot (350) includes a laterally extending, ball-shaped proximal socket (354) that is configured to receive ball end (364) of valve rod (360). Slot (350) is further configured to enable valve rod (360) to extend distally from stem (340), with distal tip (362) and the remainder of valve rod (360) in coaxial alignment with stem (340). As will be described in greater detail below, valve rod (360) translates longitudinally during operation of spray gun (10). This longitudinal translation may impose various stresses (e.g., transversely directed stresses) on valve rod (360) during operation of spray gun (10). The configuration of ball end (364) and socket (354) may allow some degree of movement of valve rod (360) relative to stem (340) (e.g., along two or more axes of movement), which may reduce or even eliminate the various stresses imposed on valve rod (360) during operation of spray gun (10). The configuration of ball end (364) and socket (354) may also facilitate assembly of piston assembly (330). Although ball end (364) and a complementarily shaped socket (354) are described herein as providing a coupling between valve rod (360) and stem (340), it should be understood that various other kinds of structures may be used to provide a coupling between valve rod (360) and stem (340). By way of example only, ball end (364) may instead have a disc shape; with socket (354) having a complementary shape. In some such examples, the disc may be centered on the longitudinal axis of rod (360) and may be oriented along a plane that is perpendicular to the longitudinal axis of rod (360). Other suitable configurations and relationships between valve rod (360) and stem (340) will be apparent to those of ordinary skill in the art in view of the teachings herein.

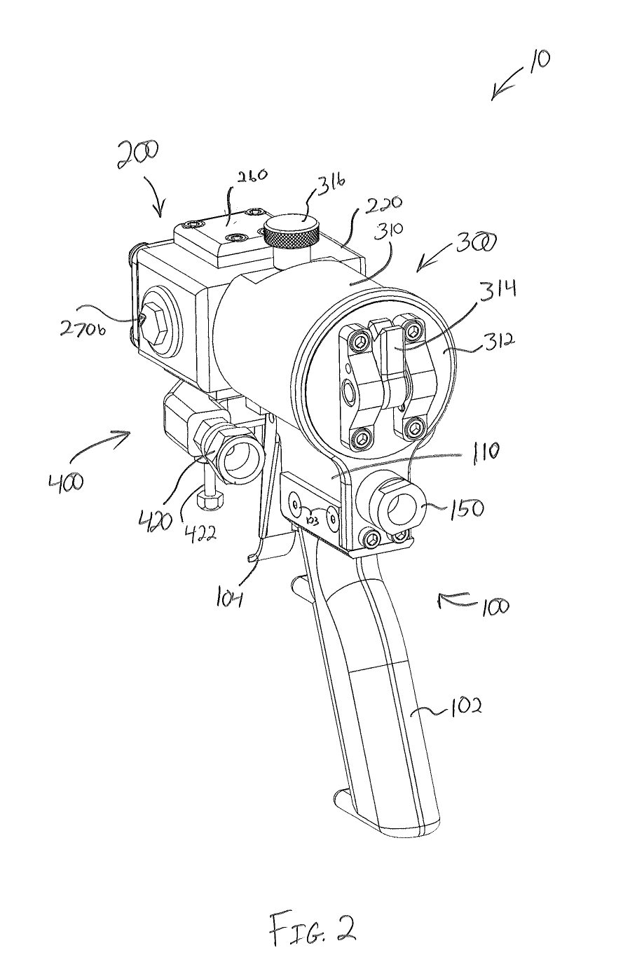

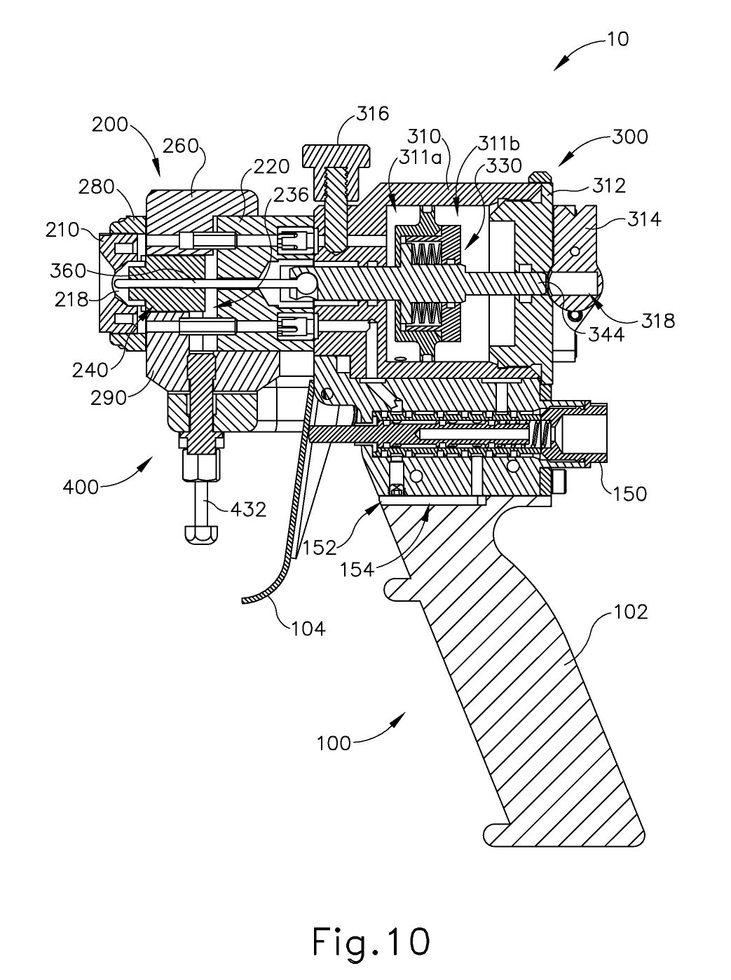

Locking member (314) is pivotally coupled with end cap (312) such that locking member (314) is pivotable between a vertical position (as shown in FIGS. 2-3, 5-7, 10-11, 20, and 30A-31) and a horizontal position (not shown). As best seen in FIGS. 10-11, 20, and 30A-30B locking member (314) defines a recess (318). Recess (318) is configured to accommodate proximal end (344) of stem (340) when piston assembly (330) is in a proximal position within bore (311), as shown in FIG. 30B. Cylinder assembly (300) is thus in an unlocked configuration when locking member (314) is in a vertical position. When locking member is pivoted to a horizontal position, recess (318) is no longer aligned with stem (340), such that locking member (314) will prevent proximal movement of piston assembly (300) within bore (311). Cylinder assembly (300) is thus in a locked configuration when locking member (314) is in a horizontal position. This locked configuration prevents spray gun (10) from operating. In some other versions, locking member (314) is replaced with a dial such that locking and unlocking may occur by rotating the dial. By way of example only, while locking member (314) is pivoted about an axis that is perpendicular to the longitudinal axis of stem (340) and rod (360), the dial may be rotated about the longitudinal axis of stem (340) and rod (360). This may provide the operator with a form of control that is the same (from the operator's perspective) regardless of the orientation of spray gun (10). Of course, in such alternative versions of locking member (314), other features such as recess (318) and/or proximal end (344) of stem (340) may be altered to accommodate the rotatable dial version of locking member (314). By way of example only, the dial may rotate a piston that advances or retracts longitudinally along the longitudinal axis of stem (340) and rod (360), to selectively permit or restrict proximal movement of stem (340) and rod (360) along the longitudinal axis. Other suitable ways in which spray gun (10) may be effectively locked and unlocked for operation will be apparent to those of ordinary skill in the art in view of the teachings herein.

IV. Exemplary Coupling Block Assembly

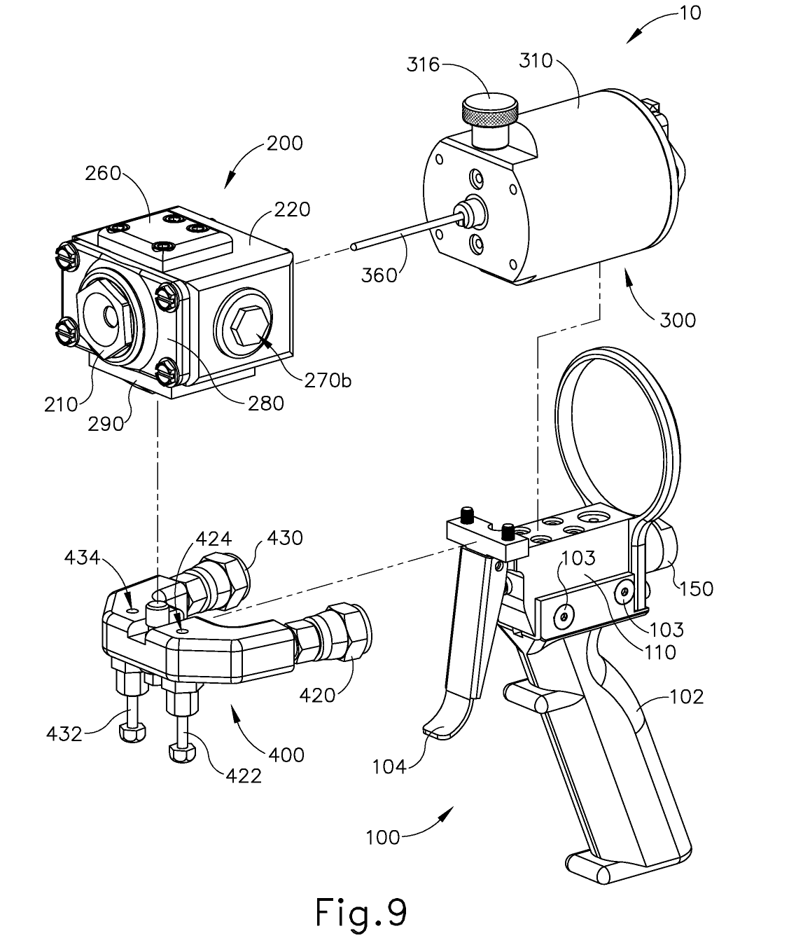

Coupling block assembly (400) of the present example comprises a first inlet port (420), a second inlet port (430), a first valve (422), and a second valve (432). Inlet ports (420, 430) comprise conventional couplings that are configured to couple with sources of materials that are to be mixed and dispensed by spray gun (10). Various suitable forms that may be taken by inlet ports (420, 430) will be apparent to those of ordinary skill in the art in view of the teachings herein. Similarly, various materials that may be communicated to inlet ports (420, 430) will be apparent to those of ordinary skill in the art in view of the teachings herein. As best seen in FIG. 9 and as noted above, first inlet port (420) is in fluid communication with a first outlet port (424); while second inlet port (430) is in fluid communication with a second outlet port (434). As also noted above, first outlet port (424) is in fluid communication with inlet port (274b) of head block (220) when spray gun (10) is assembled; while second outlet port (434) is in fluid communication with inlet port (274a) of head block (220) when spray gun (10) is assembled. First valve (422) is operable to selectively adjust the flow rate from first inlet port (420) to first outlet port (424). Second valve (432) is operable to selectively adjust the flow rate from second inlet port (430) to second outlet port (434). Various suitable forms that may be taken by valves (422, 432) will be apparent to those of ordinary skill in the art in view of the teachings herein. Similarly, other various components, features, and configurations that may be incorporated into coupling block assembly (400) will be apparent to those of ordinary skill in the art in view of the teachings herein.

V. Exemplary Manifold Assembly

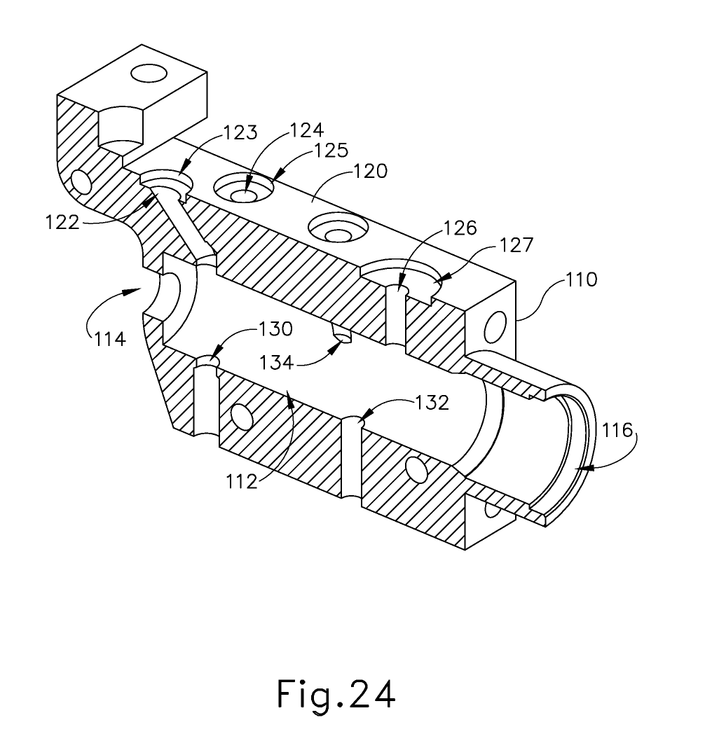

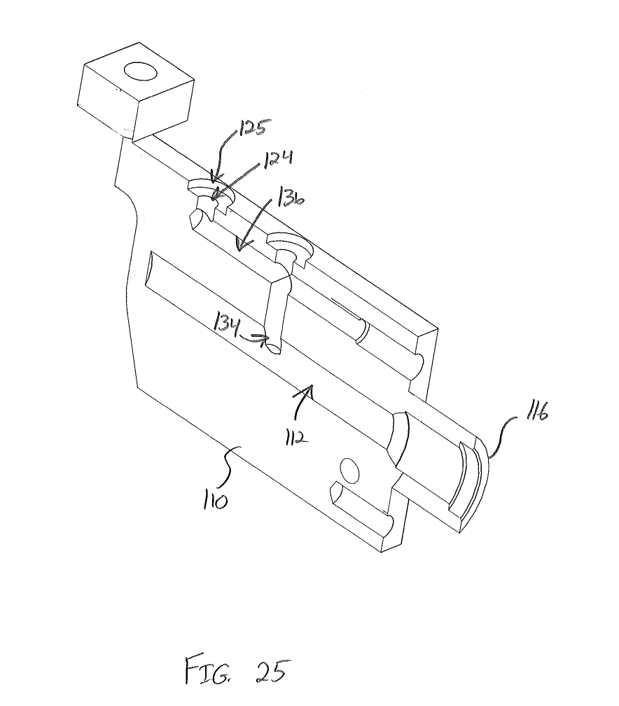

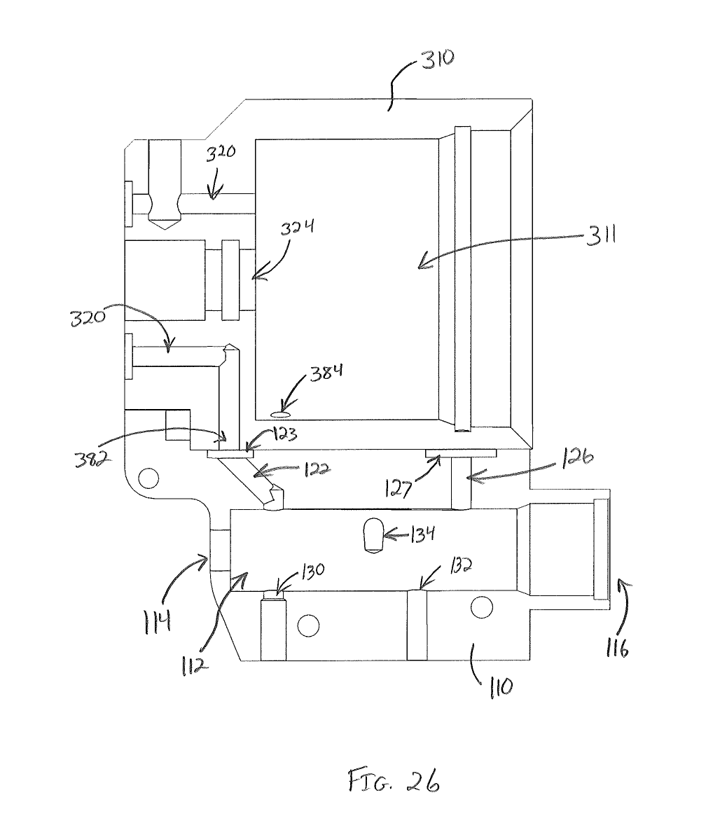

As noted above, manifold assembly (100) of the present example comprises grip (102), trigger (104), manifold block (110), and inlet port (150). As best seen in FIGS. 23-27, manifold block (110) defines a manifold chamber (112) having a distal opening (114) and a proximal opening (116). Inlet port (150) is in fluid communication with manifold chamber (112) via proximal opening (116). A distal port (122), intermediate port (134), and proximal port (126), are also in fluid communication with manifold chamber (112). As best seen in FIG. 24, distal port (122) leads to a first recess (123) formed in the top side of manifold block (110). As also best seen in FIG. 24, proximal port (126) leads to a third recess (127) formed in the top side of manifold block (110). As best seen in FIG. 25, intermediate port (134) leads to a passageway (136), which further leads to another port (124) at a second recess (125). While only one intermediate port (134) is shown, manifold chamber (112) of the present example includes another intermediate port (134) at the same longitudinal position and at the opposite lateral side of manifold chamber (112). This obscured intermediate port (134) is in fluid communication with another port (124), which is at the same longitudinal position and adjacent to port (124) as shown in FIG. 23.

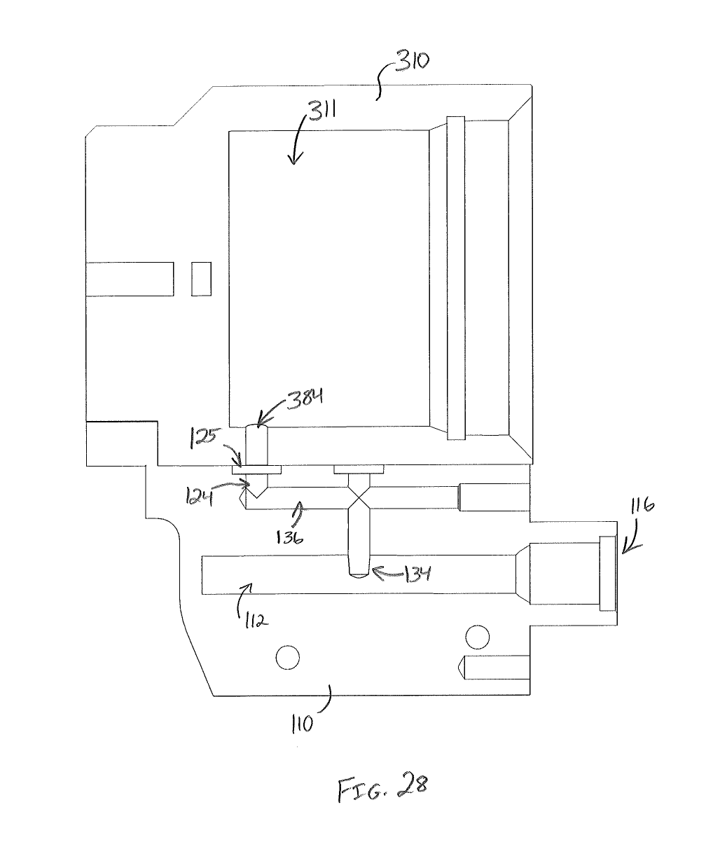

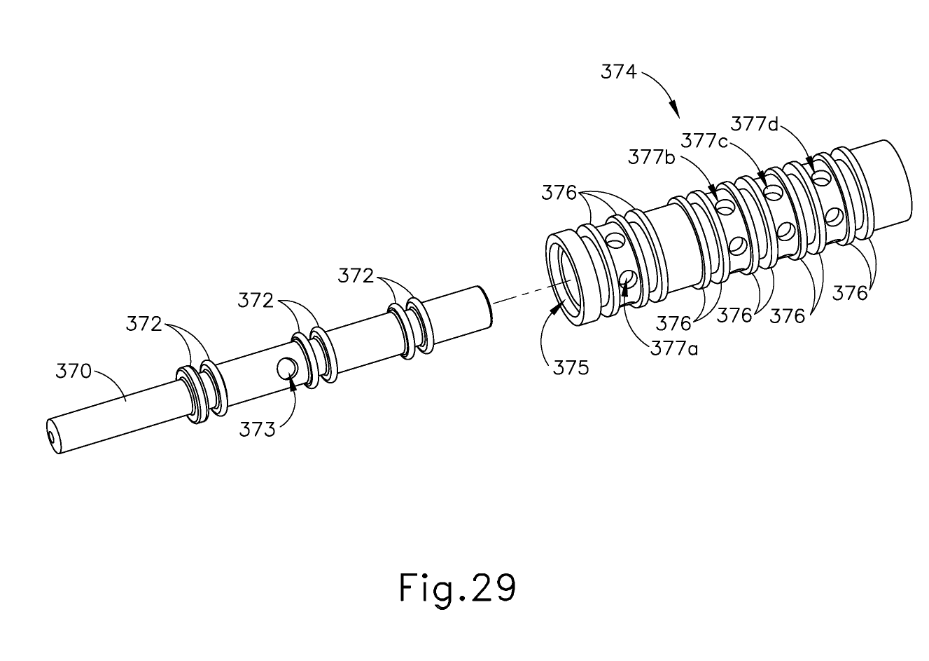

As shown in FIGS. 23 and 26-28, various openings (382, 384, 386) in cylinder body (310) are configured to communicate with manifold chamber (112) via recesses (123, 125, 127) and ports (122, 124, 126). In particular, when cylinder body (310) is coupled with manifold block (110), opening (382) is positioned above recess (123) and is thereby in fluid communication with port (122) as shown in FIGS. 26-27. As also shown in FIG. 27, openings (386) are positioned above recess (127) and are thereby in fluid communication with port (126). While a pair of laterally offset openings (386) are provided in the present example, some other versions may have just one (e.g., centered) opening (236) in fluid communication with port (126). As shown in FIG. 28, openings (384) are positioned above recesses (125) and are thereby in fluid communication with ports (124). Openings (382, 384, 386) are in fluid communication with the hollow interior (311) of cylinder body (310) such that openings (382, 384, 386), recesses (123, 125, 127), and ports (122, 124, 126) together provide paths for fluid communication between manifold chamber (112) and hollow interior (311) of cylinder body (310). It should be understood that one or more seals, gaskets, and/or other features may be provided at the interface between cylinder body (310) and manifold block (110) to prevent undesired leakage of pressurized fluid while still permitting fluid communication through the paths identified above.

As shown in FIGS. 24, 26-27, and 30A-30B, manifold block (110) further defines a pair of lower ports (130, 132) that are in fluid communication with manifold chamber (112). As shown in FIGS. 1 and 30A-30B, the upper portion of grip (102) defines a vent recess (151) that terminates in a distal vent opening (152) formed between grip (102) and manifold block (110). Lower port (132), vent recess (151), and vent opening (152) thus provide a vent path between manifold chamber (112) and atmospheric air. In some the present example, a set screw (135) is positioned in lower port (130), such that lower port (130) essentially serves no pneumatic purpose in the present example. It should therefore be understood that lower port (132) serves as the sole vent path between manifold chamber (112) and vent recess (151) in the present example. It should also be understood that port (130) may simply be omitted; and/or that any other suitable configurations and arrangements may be used.

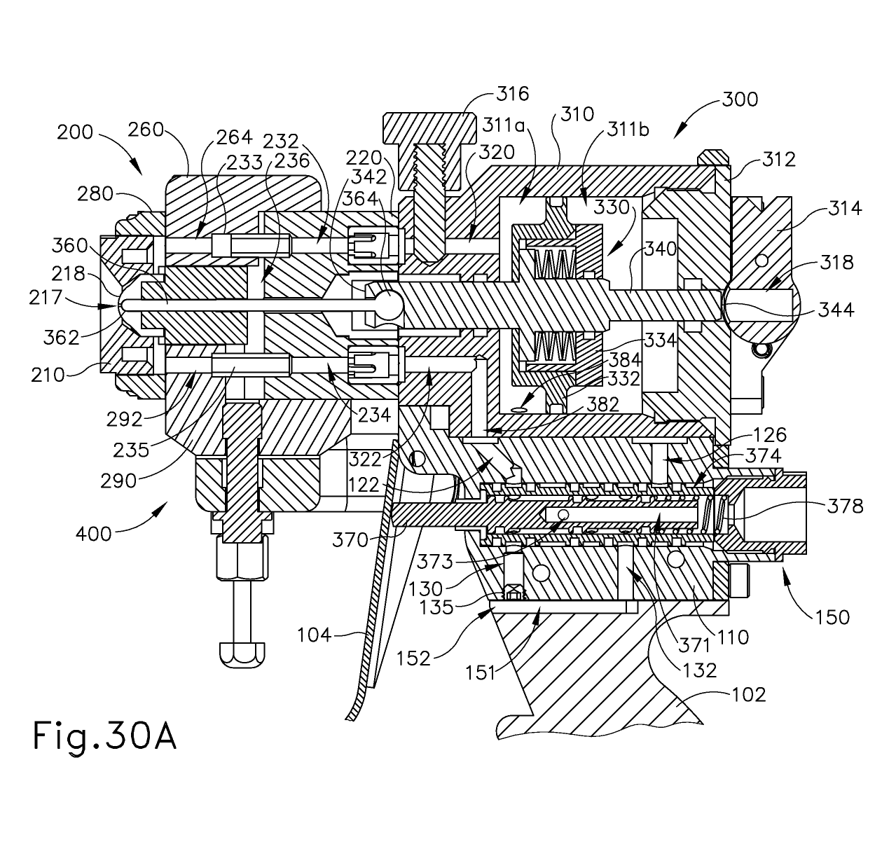

The fluid communication state of ports (122, 124, 126, 130, 132) is governed by a spool valve (370) and valve body (374), which are shown in FIGS. 29-30B. Valve body (374) is fixedly disposed in manifold chamber (112). Spool valve (370) is slidably disposed within a bore (375) of valve body (374). A coil spring (378) resiliently biases spool valve (370) distally. Since spool valve (370) is in contact with trigger (104), coil spring (378) also biases trigger (104) away from grip (102) via spool valve (370). Spool valve (370) includes several pairs of annular flanges (372), a bore (371), and a lateral opening (373) that is in fluid communication with bore (371). While not shown in the drawings, o-rings may be disposed between the flanges (372) of each pair of flanges (372). Such o-rings may provide a fluid tight seal against the inner diameter wall of valve body (374) while permitting spool valve (370) to translate longitudinally within bore (375) of valve body (374).

Valve body (374) also includes several pairs of annular flanges (376) and several angular arrays of lateral openings (377) that are in fluid communication with bore (375). While not shown in the drawings, o-rings may be disposed between the flanges (376) of each pair of flanges (376). Such o-rings may provide a fluid tight seal against the inner diameter wall of manifold chamber (112). It should be understood that one set of lateral openings (377a) is at the same longitudinal position as (and is thus in fluid communication with) port (122), such that lateral openings (377a) are in fluid communication with openings (382). Another set of lateral openings (377b) is at the same longitudinal position as (and is thus in fluid communication with) ports (134), such that lateral openings (377b) are in fluid communication with ports (124) and openings (384). Another set of lateral openings (377c) is at the same longitudinal position as (and is thus in fluid communication with) port (132), such that lateral openings (377c) are in fluid communication with vent recess (151) and vent opening (152). Another set of lateral openings (377d) is at the same longitudinal position as (and is thus in fluid communication with) port (126), such that lateral openings (377d) are in fluid communication with openings (386). Changing the longitudinal position of spool valve (370) within valve body (374) changes the pneumatic states of ports (122, 134, 126), as will be described in greater detail below.

FIG. 30A shows spray gun (10) in an idle state. In this configuration, trigger (104) is pivoted away from grip (102), piston assembly (300) is in a distal position, and spool valve (370) is in a distal position. With piston assembly (300) in this distal position, valve rod (360) effectively blocks inlet passageways (254, 258) in mixing chamber insert (240), thus preventing materials received through inlet ports (420, 430) of coupling block assembly (400) from reaching mixing passageway (250). With spool valve (370) in the distal position, pressurized fluid communicated to inlet port (150) passes through bore (371) of spool valve (370), through lateral opening (373) of spool valve (370), through the distal-most set of lateral openings (377a) of valve body (370), and thereby through port (122). This pressurized fluid is thus further communicated through opening (382), through passageways (322, 234), through sleeve (235), through passageway (292), through cylindraceous recess (216), through passageways (215), and ultimately through gap (219) to atmosphere. As the pressurized fluid escapes through gap (219), the pressurized fluid purges or removes materials built up on adjacent surfaces (214, 212) of pattern control tip (218) and air cap (210). The pressurized fluid thus provides a continuously cleaning stream while spray gun (10) is in the idle state.

Also while spray gun (10) is in the idle state as shown in FIG. 30A, pressurized fluid communicated to inlet port (150) passes between the exterior of spool valve (370) and the interior of valve body (374), thereby passing through the proximal-most set of lateral openings (377d) in valve body (374). The pressurized fluid is thus further communicated through port (126) to the proximal portion of hollow interior (311b) via openings (386). The pressurized fluid in proximal portion of hollow interior (311b) bears distally on the proximal end of piston assembly (330), thereby holding piston assembly (330) in the distal position. It should also be understood that spool valve (370) vents the distal portion of hollow interior (311a) to atmosphere via port (132), vent recess (151), and vent opening (152) when spray gun (10) is in the idle state. In particular, lateral openings (377b) are in fluid communication with ports (124) and openings (384) as noted above, while lateral openings (377c) are in fluid communication with port (132), vent recess (151) and vent opening (152). Spool valve (370) places lateral openings (377b) in fluid communication with lateral openings (377c) when spray gun (10) is in the idle state, thereby providing a pathway for the distal portion of hollow interior (311a) to vent to atmosphere.

FIG. 30B shows spray gun (10) in an actuated state. In this configuration, the operator has squeezed trigger (104) to pivot trigger (104) toward grip (102), driving spool valve (370) to a proximal position. Piston assembly (300) is also in a proximal position. With piston assembly (300) in this proximal position, valve rod (360) unblocks inlet passageways (254, 258) in mixing chamber insert (240), thus allowing materials received through inlet ports (420, 430) of coupling block assembly (400) to reach and mix in mixing passageway (250). This further allows the mixture to be conveyed distally through mixing passageway (250) and ultimately through distal opening (217) of pattern control tip (218).

With spool valve (370) in the proximal position as shown in FIG. 30B, pressurized fluid communicated to inlet port (150) passes through bore (371) of spool valve (370), through lateral opening (373) of spool valve (370), through the lateral openings (377b) of valve body (370), and thereby through port (134). This pressurized fluid is thus further communicated through opening (384), thereby reaching the distal portion of hollow interior (311a). The pressurized fluid in distal portion of hollow interior (311a) bears proximally on the distal end of piston assembly (330), thereby driving piston assembly (330) to the proximal position. It should also be understood that spool valve (370) vents the proximal portion of hollow interior (311b) to atmosphere via port (132), vent recess (151), and vent opening (152) when spray gun (10) is in the actuated state. In particular, lateral openings (377d) are in fluid communication with port (126) and openings (386) as noted above, while lateral openings (377c) are in fluid communication with port (132), vent recess (151) and vent opening (152). Spool valve (370) places lateral openings (377c) in fluid communication with lateral openings (377d) when spray gun (10) is in the actuated state, thereby providing a pathway for the proximal portion of hollow interior (311b) to vent to atmosphere. This venting enables air to escape the proximal portion of hollow interior (311b) when piston assembly (330) travels proximally in response to pressurized fluid in the distal portion of hollow interior (311a).

In addition, the pressurized fluid is further communicated from the distal portion of hollow interior (311a) to passageway (320), through passageway (232), through sleeve (233), through passageway (264), through cylindraceous recess (216), through passageways (215), and ultimately through gap (219) to atmosphere. As noted above, the mixture of material from ports (420, 430) via passageways (254, 258) is expelled through distal opening (217) of pattern control tip (218) while pressurized fluid is being expelled through gap (219). As the mixture of material passes through distal opening (217) of pattern control tip (218), the pressurized fluid that is being expelled through gap (219) will distribute the mixture distally in a spray pattern. In other words, the pressurized fluid expelled through gap (219) combines with the mixture expelled through distal opening (217) to form a sprayed mixture. The pressurized fluid thus provides a spray of the mixed material from pattern control tip (218) while spray gun (10) is in the actuated state shown in FIG. 30B.

When the operator releases trigger (104) from the position shown in FIG. 30B, the resilient bias of spring (378) will drive spool valve (370) distally, which will in turn pivot trigger (104) distally back to the position shown in FIG. 30A. When spool valve (370) has translated from the proximal position (FIG. 30A) back to the distal position (FIG. 30B), the pneumatic states of hollow interior portions (311a, 311b) will be reversed. In particular, distal portion (311a) will be vented to atmosphere while proximal portion (311b) will receive pressurized fluid as described above. This pressure differential will translate piston assembly (330) distally to the position shown in FIG. 30A. Valve rod (360) will thus again effectively block inlet passageways (254, 258) in mixing chamber insert (240); and pressurized fluid will exit spray gun (10) through gap (219) to thereby remove materials built up on adjacent surfaces (214, 212) of pattern control tip (218) and air cap (210). It should be understood that spray gun (10) may transition between the idle state and the actuated state as many times as desired, based on the operator selectively squeezing and releasing trigger (104). As spray gun (10) transitions between these states, valve rod (360) reciprocates within mixing passageway (250) of mixing chamber insert (240). This reciprocation of valve rod (360) may provide a mechanical cleaning action in mixing passageway (250), preventing buildup of debris in mixing passageway. It should also be understood from the foregoing that the pathway for pressurized fluid in a cleaning stream is separate and independent from the pathway for pressurized fluid in a mixed material dispensing stream. Moreover, the pathway for pressurized fluid in a cleaning stream is substantially open; whereas the pathway for pressurized fluid in a mixed material dispensing stream is modulated by needle valve (316).

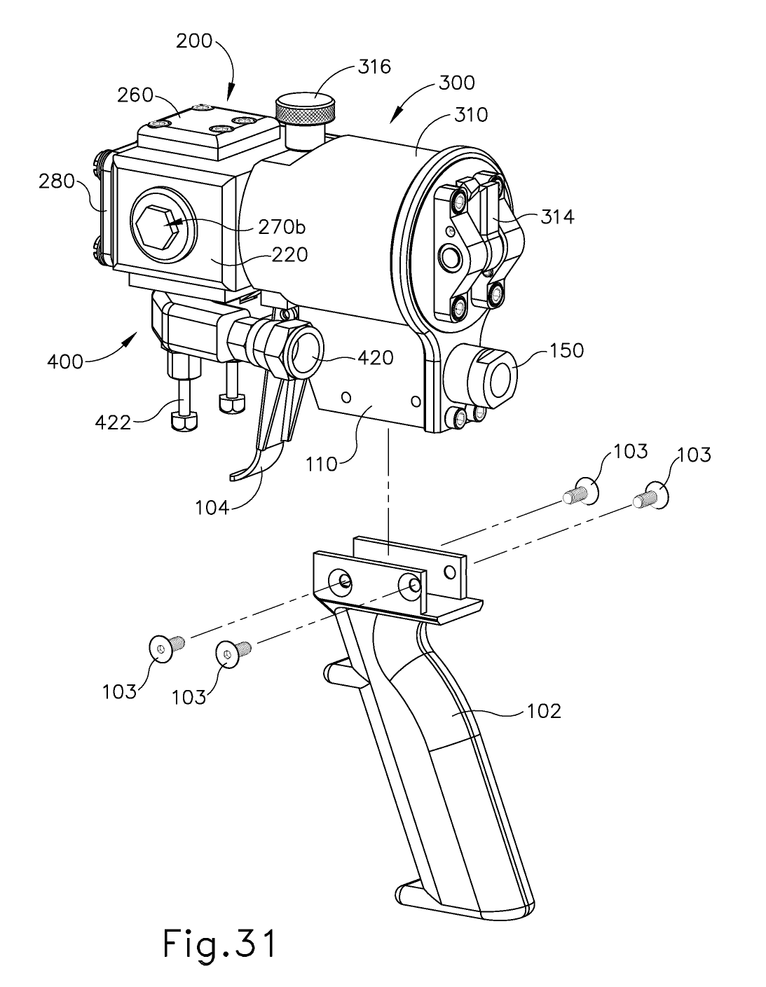

As best seen in FIG. 31, grip (102) is removable from manifold block (110) in the present example. In particular, grip is selectively secured to manifold block (110) by a set of four screws (103). It should be understood that any other suitable components and/or features may be used to selectively secure grip (102) to manifold block (110). It should also be understood that an operator may select from various kinds of grips (102) in order to secure a selected grip (102) to manifold block (110). Such a selection of grips (102) may vary based on the size of grip (102), the orientation of grip (102), the shape of grip (102), and or other structural aspects. Various suitable kinds of grip (102) that may be coupled with manifold block (110) will be apparent to those of ordinary skill in the art in view of the teachings herein. Similarly, various suitable ways in which grip (102) may be selectively secured to manifold block (110) will be apparent to those of ordinary skill in the art in view of the teachings herein. In some other versions, grip (102) is not removable from manifold block (110).

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. A spray gun comprising:
(a) a first block, wherein the first block comprises:
(i) a plurality of fluid passageways,
(ii) a first sealing face, wherein a first fluid passageway of the plurality of fluid passageways terminates in the first sealing face, and
(iii) a second sealing face, wherein a second fluid passageway of the plurality of fluid passageways terminates in the second sealing face; and
(b) a mixing feature operable to mix mixture components communicated through the first and second fluid passageways, wherein the mixing feature comprises:
(i) a third sealing face adjacent to the first sealing face, wherein the third sealing face includes a first conduit in fluid communication with the first fluid passageway,
(ii) a fourth sealing face adjacent to the second sealing face, wherein the fourth sealing face includes a second conduit in fluid communication with the second fluid passageway, and
(iii) a mixture chamber in fluid communication with the first and second conduits, wherein the mixing chamber defines a longitudinal axis,
wherein the first, second, third, and fourth sealing faces are each oriented obliquely relative to the longitudinal axis of the mixing chamber;
wherein the spray gun is operable to distribute a mixture formed in the mixing chamber as a spray driven by pressurized fluid.

2. The spray gun of claim 1, wherein the third sealing face of the mixing feature is in contact with the first sealing face of the first block, wherein the fourth sealing face of the mixing feature is in contact with the second sealing face of the first block.

3. The spray gun of claim 2, wherein the interface between the third sealing face of and the first sealing face includes a first sealing member configured to fluidly seal the interface between the third sealing face and the first sealing face, wherein the interface between the fourth sealing face and the second sealing face includes a second sealing member configured to fluidly seal the interface between the fourth sealing face and the second sealing face.

4. The spray gun of claim 3, wherein the first sealing member and the second sealing member comprises a seal or gasket.

5. The spray gun of claim 1, further comprising a first input and a second input, wherein the first input is configured to receive a first mixture component, wherein the second input is configured to receive a second mixture component.

6. The spray gun of claim 5, wherein the first input is in communication with the first fluid passageway, wherein the second input is in communication with the second fluid passageway.

7. The spray gun of claim 1, further comprising a spray feature configured to expel a mixture formed in the mixing feature, wherein the spray feature is in communication with the first and second conduits.

8. The spray gun of claim 7, wherein the spray feature comprises a cap member and a spray tip, wherein the cap member is selectively secured to the first block, wherein the cap member defines a central opening.

9. The spray gun of claim 8, wherein the spray tip is interposed between the cap member and the first block, wherein the spray tip includes an opening configured to expel a mixture formed in the mixing feature, wherein the spray feature is positioned relative to the cap member to permit expulsion of the mixture via the opening in the spray tip.

10. The spray gun of claim 9, wherein the cap member is configured to selectively secure the spray tip to the mixing block.

11. The spray gun of claim 1, further comprising a piston assembly, wherein the piston assembly is configured to selectively actuate the mixing feature between a spraying configuration and a non-spraying configuration.

12. The spray gun of claim 11, wherein the piston assembly includes a head assembly and a rod extending from the head assembly, wherein the rod is translatable by the head assembly, wherein the rod is configured to actuate the mixing feature between the spraying configuration and the non-spraying configuration by translating relative to the mixing feature.

13. The spray gun of claim 12, wherein the head assembly is configured to be driven by a pressurized fluid to drive the rod longitudinally relative to the mixing feature.

14. The spray gun of claim 11, wherein the piston assembly further includes a resilient member configured to bias the rod distally relative to the head assembly.

15. The spray gun of claim 12, wherein the resilient member of the piston assembly comprises a plurality of Belleville washers.

16. A spray gun, comprising:
(a) a first input configured to receive a first mixture component;
(b) a second input configured to receive a second mixture component; and
(c) a mixing feature operable to mix the first and second mixture components together to form a mixture, wherein the mixing feature comprises:
(i) a first conduit in fluid communication with the first input,
(ii) a second conduit in fluid communication with the second input, and
(iii) a mixing chamber in fluid communication with the second conduits, wherein the mixing chamber defines a longitudinal axis,
wherein the first and second conduits are each oriented obliquely relative to the longitudinal axis of the mixing chamber;
wherein the spray gun is operable to distribute a mixture formed in the mixing chamber as a spray driven by pressurized fluid.

17. The spray gun of claim 16, further comprising a head block, wherein the head block comprises a first fluid passage and a second fluid passage, wherein the first fluid passage is in communication with the first conduit of the mixing feature, wherein the second fluid passage is in communication with the second conduit of the mixing feature, wherein the first and second conduit are in fluid communication with the first and second inputs via the first and second fluid passages, respectively.

18. The spray gun of claim 17, wherein the mixing feature has a triangular shape, wherein at least a portion of the head block includes a triangular cutout corresponding to the triangular shape of the mixing feature, wherein the mixing feature is insertable into the triangular cut out.

19. The spray gun of claim 17, further comprising a coupling block, wherein the coupling bock comprises the first and second inputs, wherein the coupling block is selectively attachable to the head block.

20. A spray gun, comprising:
(a) a first input configured to receive a first mixture component;
(b) a second input configured to receive a second mixture component;
(c) a mixing feature operable to mix the first and second mixture components together to form a mixture;
(d) a third input configured to receive a pressurized fluid;
(e) a spray feature configured to expel a mixture formed in the mixing feature;
(f) a first pressurized fluid passageway;
(g) a second pressurized fluid passageway; and
(h) a valve assembly operable to transition between a first state and a second state;
wherein the valve assembly in the first state is configured to couple the third input with the first pressurized fluid passageway to distribute the mixture formed in the mixing chamber as a spray driven by pressurized fluid via the spray feature;
wherein the valve assembly in the second state is configured to couple the third input with the second pressurized fluid passageway to clear material from the spray feature.
